(19) United States
(12) Patent Application Publication
(10) Pub. No.: US 2024/0022327 A1
(43) Pub. Date: Jan. 18, 2024

(54) DEVICES FOR INTERCONNECTING NODES IN A DIRECT INTERCONNECT NETWORK

(71) Applicant: Rockport Networks Inc., Ottawa (CA)

(72) Inventors: Matthew Robert WILLIAMS, Kanata (CA); John BOBYN, Kanata (CA); Richard Glenn KUSYK, Ottawa (CA)

(21) Appl. No.: 17/785,777

(22) PCT Filed: Nov. 3, 2021
(86) PCT No.: PCT/IB2021/000753

§ 371 Date: Jun. 15, 2022

Related U.S. Application Data
(60) Provisional application No. 63/109,096, filed on Nov. 3, 2020.

(51) Int. Cl. H04B 10/27; G02B 6/38

(52) U.S. Cl. CPC H04B 10/271; G02B 6/3897

(57) ABSTRACT

A passive optical device for implementing a direct interconnect network of nodes or clients in a network topology, said device comprising: a housing comprising a plurality of node port connectors and an internal fiber shuffle mechanism, wherein each of said plurality of node port connectors is connected to a node port shuffle cable that extends within the housing to the internal fiber shuffle mechanism, and wherein each of said plurality of node port shuffle cables comprises transmit and receive optical fibers that are cross connected within the internal fiber shuffle mechanism to transmit and receive optical fibers of other of the node port shuffle cables from the plurality of node port connectors to form optical paths between said node port connectors to implement the network topology, and wherein each of said node port connectors is also initially connected to a first-type R-key to maintain in-line connections within the network topology, and wherein said first-type R-key s are replaceable in a pre-determined order by a connection to a node or client to add said node or client at an optimal location within the network topology during build out of the direct interconnect network.

### FIELD OF THE INVENTION

The present invention relates to devices for interconnecting nodes in a direct interconnect network. More particularly, the present invention relates to the manufacture and use of novel lower and upper level shuffles that are capable of connecting nodes in an optimal configuration in a direct interconnect network during build out.

### BACKGROUND OF THE INVENTION

Today's typical server clusters are based on independent switches organized in a hierarchical tree structure (spine-and-leaf network architecture). This traditional and complex architectural model features top-of-rack switches that require duplicate hardware for redundancy, and networks of switches in switch layers making independent decisions.

Such network topologies, however, are not pragmatic for modern day networks and data centers as they are fraught with problems, including that they: i) require complex wiring; ii) involve switch queues that add significant latency and are designed to drop packets; iii) use huge amounts of energy; (iv) are difficult and costly to scale; v) are not efficient at handling large amounts of east-west traffic; and vi) are susceptible to known security issues as a result of the use of independent switches.

FIGS. 1a-d assist with explaining the challenges concerning the scaling of traditional switch networks. As shown in FIG. 1a, a common 48 port switch can handle up to 48 nodes, assuming no redundancy is required. However, to maintain a non-blocking network, only half of the leaf switch ports can be used for nodes; the other half of the leaf switch ports are used to connect to other switches. As a result, as shown in FIG. 1b, adding a 49^{th} node to the network requires the addition of 4 more switches. The numbers become much more daunting as the network becomes larger. As shown in FIG. 1c, two layers of 48 port switches can support up to 1152 devices, only 576 with redundancy. In such a configuration each node consumes 3 switch ports, 6 with redundancy. The chart at FIG. 1c also provides the relevant numbers for a 2:1 oversubscription of north-south links. Figure id shows that you must add a third layer of switches in order to add the 1,153 node to the structure at FIG. 1c. With this structure, each node consumes 5 switch ports, 10 with redundancy. In the result, it is apparent that scalability in traditional networks is non-linear and expensive from both a CAPEX (capital expenditure) and OPEX (operating expense) viewpoint.

The use of direct interconnect networks can overcome some of the above-noted issues, but they can be difficult to implement and often require a large amount of complex cabling that can take weeks or months to wire. U.S. Pat. Nos. 9,965,429 and 10,303,640 to Rockport Networks Inc., however, describe systems that provide for the easy deployment of such network topologies and disclose a novel method for managing the wiring and growth of direct interconnect networks implemented on torus or higher radix interconnect structures.

The systems of U.S. Pat. Nos. 9,965,429 and 10,303,640 involve the use of a passive patch panel having connectors that are internally interconnected (e.g. in a mesh) within the passive patch panel. In order to provide the ability to easily grow the network structure, the connectors are initially populated by interconnect plugs to initially close the ring connections. By simply removing and replacing an interconnect plug with a connection to a node, the node is discovered and added to the network structure. If a person skilled in the art of network architecture desired to interconnect all the nodes in such a passive patch panel at once, there are no restrictions—the nodes can be added in random fashion. This approach greatly simplifies deployment, as nodes are added/connected to connectors without any special connectivity rules, and the integrity of the torus structure is maintained.

The present invention discloses a shuffle, a novel optical interconnect device that connects fiber paths to other fiber paths within an enclosure to create an optical channel between nodes or clients, as well as a method for manufacturing and using same. The optical paths are pre-determined to create a direct interconnect structure. The pre-determined internal connections are preferably optimized such that when nodes or clients are connected to the shuffle in a predetermined manner an optimal interconnect network is created during build-out. Special R-keys are provided to maintain in-line connections for ports not populated by a node or client, or to provide enhanced connectivity by creating cut through paths or short cut links within the fabric. The present invention also discloses novel methods of connecting shuffles to grow network structures in an optimal manner, including in increased dimensions, by connecting lower level shuffles to upper level shuffles. Also disclosed are shuffle embodiments that provide for efficient and simple node or client to device or peripheral component connectivity.

### SUMMARY OF THE INVENTION

In one aspect, the present invention provides a passive optical device for implementing a direct interconnect network of nodes or clients in a network topology, said device comprising: a housing comprising a plurality of node port connectors and an internal fiber shuffle mechanism, wherein each of said plurality of node port connectors is connected to a node port shuffle cable that extends within the housing to the internal fiber shuffle mechanism, and wherein each of said plurality of node port shuffle cables comprises transmit and receive optical fibers that are cross connected within the internal fiber shuffle mechanism to transmit and receive optical fibers of other of the node port shuffle cables from the plurality of node port connectors to form optical paths between said node port connectors to implement the network topology, and wherein each of said node port connectors is also initially connected to a first-type R-key to maintain in-line connections within the network topology, and wherein said first-type R-keys are replaceable in a pre-determined order by a connection to a node or client to add said node or client at an optimal location within the network topology during build out of the direct interconnect network.

The passive optical device may further include: a plurality of trunk port connectors, wherein each of said plurality of trunk port connectors is connected to a trunk port shuffle cable that extends within the housing to the internal fiber shuffle mechanism, and wherein each of said plurality of trunk port shuffle cables comprises transmit and receive optical fibers that are cross connected within the internal fiber shuffle mechanism to transmit and receive optical fibers of node port shuffle cables from the plurality of node port connectors within the network topology, and wherein each of said trunk port connectors is also initially connected to a second-type R-key to provide enhanced connectivity within the network topology, and wherein said second-type R-keys are replaceable by a connection to another passive optical device to expand the direct interconnect network.

The network topology of the direct interconnect network may be any one of a torus, dragon fly, slim fly, or other higher radix direct interconnect network topology.

In another aspect, the present invention provides an optical lower level shuffle for implementing a direct interconnect network of nodes or clients in a network topology, said shuffle comprising: a plurality of node port connectors, each such connector connected to fiber optic fibers that are cross connected in the shuffle with fiber optic fibers of other of the plurality of node port connectors to implement the network topology in one or more dimensions, and a plurality of trunk port connectors, each such connector connected to fiber optic fibers that are cross connected in the shuffle with fiber optic fibers of the plurality of node port connectors to allow for expansion of the network topology in one or more additional dimensions through connection to at least one upper level shuffle, wherein each node port connector is initially populated by a first-type R-key to initially close one or more connections of the direct interconnect network, and wherein each of said first-type R-key is replaceable in a pre-determined order by a connection to a node or client to add said node or client at an optimal location in the network topology during build out of the direct interconnect network, and wherein each trunk port connector is initially populated by a second-type R-key to provide enhanced connectivity between nodes or clients in the direct interconnect network, and wherein each of said second-type R-key is replaceable by a connection to an upper level shuffle to expand the network topology in one or more additional dimensions.

The network topology of the direct interconnect network may be any one of a torus, dragon fly, slim fly, or other higher radix direct interconnect network topology.

In yet another aspect, the present invention provides an optical lower level shuffle for implementing a direct interconnect network of nodes or clients in a network topology, said shuffle comprising: a chassis comprising a faceplate and housing an internal fiber shuffle sub-assembly, wherein said faceplate includes node ports comprising node port connectors, wherein each of said node port connectors is connected on an internal face of the faceplate to a node port shuffle cable having a plurality of transmit and receive fibers extending into the internal fiber shuffle sub-assembly and cross connected therein with transmit and receive fibers of other of the node port shuffle cables in a pre-determined manner to form optical paths between said node port connectors to implement the network topology, and wherein each of said node port connectors is initially connected on an external face of the faceplate to a primary fiber R-key for maintaining in-line connections in the direct interconnect network, said primary fiber R-keys replaceable in a pre-determined order with a connection to a node or client to add said node or client at an optimal location within the network topology during build out of the direct interconnect network.

The faceplate may further include trunk ports comprising trunk port connectors, wherein each of said trunk port connectors is connected on an internal face of the faceplate to a trunk port shuffle cable having a plurality of transmit and receive fibers extending into the internal fiber shuffle sub-assembly and cross connected therein with transmit and receive fibers of the node port shuffle cables to allow for network expansion, and wherein each of said trunk port connectors is initially connected on an external face of the faceplate to a secondary fiber R-key for providing enhanced connectivity between nodes or clients in the direct interconnect network, said secondary fiber R-keys replaceable with a connection to an optical upper level shuffle for network or dimension expansion.

Once again, the network topology of the direct interconnect network may be any one of a torus, dragon fly, slim fly, or other higher radix direct interconnect network topology.

In yet a further aspect, the present invention provides an optical upper level shuffle for increasing network or dimension expansion of a direct interconnect network of nodes or clients interconnected in a lower level shuffle, said optical upper level shuffle comprising: a housing comprising a plurality of connectors and an internal fiber shuffle mechanism, wherein said plurality of connectors are organized into groups of connectors, wherein each connector within each group of connectors is connected to fiber optic fibers that are cross connected in the internal fiber shuffle mechanism with fiber optic fibers of at least one other connector in the same group of connectors to implement dimension loops, and wherein each connector in the plurality of connectors is connectable to a trunk port connector in the lower level shuffle to increase network or dimension expansion of the direct interconnect network.

In yet another aspect, the present invention provides an optical upper level shuffle for increasing network or dimension expansion of a direct interconnect network of nodes or clients interconnected in a lower level shuffle, said optical upper level shuffle comprising: a chassis comprising a faceplate and housing an internal fiber shuffle sub-assembly, wherein said faceplate includes a plurality of connectors organized into groups of connectors, wherein each connector within each group of connectors is connected on an internal face of the faceplate to a shuffle cable having a plurality of transmit and receive fibers extending into the internal fiber shuffle sub-assembly and cross connected therein with transmit and receive fibers of at least one other of the shuffle cables in the same group of connectors to form optical paths between said connectors to implement dimension loops, and wherein each connector in the plurality of connectors is connectable to a trunk port connector in the lower level shuffle to increase network or dimension expansion of the direct interconnect network.

In another aspect, the present invention provides a passive optical device for directly connecting nodes or clients to devices or peripheral components, said device comprising: a housing comprising a plurality of connectors organized into at least two groups of connectors, namely at least one first group of node connectors, and at least one second group of device connectors, wherein each node connector in the at least one first group of node connectors is connected within the housing to a shuffle cable comprising transmit and receive optical fibers that is connected to at least one device connector within the at least one second group of device connectors to provide two-way node or client to device or peripheral component connectivity, and wherein each node connector in the at least one first group of node connectors is connectable to an external node or client, and wherein each device connector in the at least one second group of device connectors is connectable to an external device or peripheral component.

In yet an additional aspect, the present invention provides a method of implementing a direct interconnect network of nodes or clients in a network topology comprising the following steps: providing a passive optical device that internally implements the wiring for the direct interconnect network in the network topology, said device comprising a faceplate having a plurality of node ports comprising node port connectors connectable to nodes or clients in one or more dimensions; initially populating each of said node port connectors with a first-type R-key to close connections to maintain continuity of the network topology; and removing in a pre-determined order a first-type R-key from a node port connector and replacing said first-type R-key with a connection to a node or client to add said node or client to the direct interconnect network at a specific location within the network topology during build out of the direct interconnect network.

The method may involve the faceplate further having a plurality of trunk ports comprising trunk port connectors connectable to at least one other passive optical device for expansion of the direct interconnect network in one or more additional dimensions; initially populating each of said trunk port connectors with a second-type R-key to provide enhanced connectivity between nodes or clients in the network topology; and removing a second-type R-key from a trunk port connector and replacing said second-type R-key with a connection to the at least one other passive optical device to expand the direct interconnect network in one or more additional dimensions.

The network topology in the method may be any one of a torus, dragon fly, slim fly, or other higher radix direct interconnect network topology.

In yet a further aspect, the present invention provides a method of implementing a direct interconnect network of nodes or clients in a network topology comprising the following steps: providing an optical lower level shuffle comprising a chassis having a faceplate and housing an internal fiber shuffle sub-assembly, wherein said faceplate includes node ports comprising node port connectors, and wherein each of said node port connectors is connected on an internal face of the faceplate to a node port shuffle cable having a plurality of transmit and receive fibers extending into the internal fiber shuffle sub-assembly and cross connected therein in a pre-determined manner with transmit and receive fibers of other of the node port shuffle cables to form optical paths between said node port connectors to implement the network topology, initially connecting each of the node port connectors on an external face of the faceplate with a primary fiber R-key to maintain in-line connections in the direct interconnect network, and replacing primary fiber R-keys in a pre-determined order with a connection to a node or client to add said node or client to the direct interconnect network at an optimal location within the network topology during build out of the direct interconnect network.

The method may involve the faceplate further including trunk ports comprising trunk port connectors, and wherein each of said trunk port connectors is connected on an internal face of the faceplate to a trunk port shuffle cable having a plurality of transmit and receive fibers extending into the internal fiber shuffle sub-assembly and cross connected therein in a pre-determined manner with transmit and receive fibers of the node port shuffle cables to form optical paths between said node port and trunk port connectors to allow for network expansion, initially connecting each of the trunk port connectors on an external face of the faceplate with a secondary fiber R-key to provide enhanced connectivity between nodes or clients in the direct interconnect network, providing an optical upper level shuffle for increasing network or dimension expansion of the direct interconnect network of nodes or clients interconnected in the lower level shuffle, said optical upper level shuffle comprising: a chassis comprising a faceplate and housing an internal fiber shuffle sub-assembly, wherein said faceplate includes a plurality of connectors organized into groups of connectors, wherein each connector within each group of connectors is connected on an internal face of the faceplate to a shuffle cable having a plurality of transmit and receive fibers extending into the internal fiber shuffle sub-assembly and cross connected therein with transmit and receive fibers of at least one other of the shuffle cables in the same group of connectors to form optical paths between said connectors to implement dimension loops, and replacing secondary fiber R-keys in the lower level shuffle with a connection to a connector in the upper level shuffle to expand the direct interconnect network.

The network topology in the method may be any one of a torus, dragon fly, slim fly, or other higher radix direct interconnect network topology.

In yet another aspect, the present invention provides a passive optical device for implementing a direct interconnect network of nodes or clients in a network topology, said device comprising: (a) a plurality of node port connectors; (b) a plurality of node port shuffle cables; (c) at least one first-type R-key; and (c) a fiber shuffle mechanism, wherein each of said plurality of node port connectors is connected to the fiber shuffle mechanism via a corresponding one of the plurality of node port shuffle cables, wherein each of said plurality of node port shuffle cables comprises transmit and receive optical fibers that are connected within the fiber shuffle mechanism to transmit and receive optical fibers of other of the node port shuffle cables from the plurality of node port connectors to form optical paths between said node port connectors to implement a network topology, wherein at least one of said node port connectors is initially connected to one of the at least one first-type R-key to maintain in-line connections within the network topology, and wherein said at least one first-type R-key are replaceable in a pre-determined order by a connection to a node or a client to add said node or said client at an optimal location within the network topology during build out of a direct interconnect network.

The passive optical device may further comprise: (a) a plurality of trunk port connectors; (b) a plurality of trunk port shuffle cables; and (c) at least one second-type R-key, wherein each of said plurality of trunk port connectors is connected to the fiber shuffle mechanism via a corresponding one of the plurality of trunk port shuffle cables, wherein each of said plurality of trunk port shuffle cables comprises transmit and receive optical fibers that are connected within the fiber shuffle mechanism to transmit and receive optical fibers of node port shuffle cables from the plurality of node port connectors within the network topology, wherein at least one of said trunk port connectors is initially connected to one of the at least one second-type R-key to provide enhanced connectivity within the network topology, and wherein said second-type R-keys are replaceable by a connection to another passive optical device to expand the direct interconnect network.

### BRIEF DESCRIPTION OF THE DRAWINGS

The invention will now be described, by way of example, with reference to the accompanying drawings in which:

FIGS. 1a to 1d are depictions relating to scaling issues concerning prior art spine-and-leaf network architectures that use switches;

FIG. 2 depicts representations of various torus or higher radix network topologies;

FIG. 3 is a photo of a network card, more particularly a Rockport R06100 Network Card;

FIG. 4a is a perspective view depiction of an embodiment of a lower level shuffle (e.g. LS24T);

FIG. 4b is a photo showing a perspective view of the embodiment of the lower level shuffle as shown in FIG. 4a with the lid removed;

FIG. 4c is a front elevation view depiction of the embodiment of the lower level shuffle as shown in FIG. 4a;

FIG. 5 is a representation of an embodiment of a lower level shuffle (LS24T), depicting locations of node ports and trunk ports, and their respective connections;

FIGS. 6a and 6b are photos of example MTP®-24 fiber R-keys;

FIGS. 7a and 7b are photos of example MTP®-32 fiber R-keys;

FIG. 8a depicts a fiber loop employed in an example MTP®-24 fiber R-key;

FIG. 8b depicts the internal connections in an example MTP®-24 fiber R-key;

FIG. 9a depicts a fiber loop employed in an example MTP®-32 fiber R-key;

FIG. 9b depicts the internal connections in an example MTP®-32 fiber R-key;

FIG. 10 is a representative shuffle connectivity diagram to assist with an initial understanding of how network growth may be implemented using the example shuffle embodiments;

FIG. 11 is a representation of an embodiment of a lower level shuffle (LS24T) with a network card connected to node port #1;

FIG. 12 depicts where nodes connected to node ports in an embodiment of a lower level shuffle (LS24T) are located within a representative notional 4×3×2 torus configuration (having u,v,w coordinates);

FIGS. 13a and 13b depict front and rear perspective views of a bottom chassis of an embodiment of a lower level shuffle (LS24T);

FIG. 14 depicts a front elevation view of an embodiment of the lower level shuffle (LS24T), showing openings where node ports and trunk ports will be located;

FIG. 15 depicts a front elevation view of an embodiment of the lower level shuffle (LS24T), showing example bulkhead adapters housed in the openings shown in FIG. 14;

FIG. 16a depicts an example bulkhead adapter used in the node ports of an embodiment of the lower level shuffle (LS24T);

FIG. 16b depicts an example bulkhead adapter used in the trunk ports of an embodiment of the lower level shuffle (LS24T);

FIG. 17 depicts a representation of a front elevation view of an embodiment of the lower level shuffle (LS24T), showing the relative locations of the example MTP®/MPO-24 and MTP®/MPO-32 optical connectors;

FIGS. 18a to 18c are representations of the channels and fibers in the example MTP®-24 optical connectors (as seen through a bulkhead adapter);

FIGS. 19a to 19c are representations of the channels and fibers in the example MTP®-32 optical connectors (as seen through a bulkhead adapter);

FIG. 20 is a top perspective view of an embodiment of the lower level shuffle (LS24T) with the lid removed, showing the internal fiber shuffle sub-assembly with the interconnected node and trunk port shuffle cables extending therefrom;

FIG. 21a is a photo of the fiber cross connect in the internal fiber shuffle sub-assembly, created using a fiber management solution;

FIG. 21b is a top elevational representation of the internal fiber shuffle sub-assembly with the interconnected node and trunk port shuffle cables extending therefrom;

FIG. 21c depicts a representation of the fibers that are internally interconnected within the internal fiber shuffle sub-assembly of the lower level shuffle (LS24T);

FIGS. 22a to 22h are charts that provide the example internal fiber cross connections within the internal fiber shuffle sub-assembly as it relates to the 24 node ports of the lower level shuffle (LS24T);

FIGS. 23a-c are charts providing the example internal fiber cross connections within the internal fiber shuffle sub-assembly as it relates to the 9 trunk ports (A1-A3, B1-B3, and C1-C3) of the lower level shuffle (LS24T);

FIG. 24 displays the enhanced connectivity created when example MTP®-32 fiber R-keys are connected to the A1-A3 trunk ports of an embodiment of the lower level shuffle (LS24T);

FIG. 25 displays the enhanced connectivity created when example MTP®-32 fiber R-keys are connected to the B1-B3 trunk ports of an embodiment of the lower level shuffle (LS24T);

FIG. 26 displays the enhanced connectivity created when example MTP®-32 fiber R-keys are connected to the C1-C3 trunk ports of an embodiment of the lower level shuffle (LS24T);

FIGS. 27a-c provide the example connection pinouts for the MTP®-32 optical connectors of the trunk ports (A1-A3, B1-B3, and C1-C3) in an embodiment of the lower level shuffle (LS24T);

FIG. 28a is a perspective view depiction of an embodiment of an upper level shuffle (e.g. US2T);

FIG. 28b is a photo showing a perspective view of the embodiment of the upper level shuffle as shown in FIG. 28a with the lid removed;

FIG. 28c is a front elevation view depiction of the embodiment of the upper level shuffle as shown in FIG. 28a;

FIG. 29 depicts a representation of the fibers that are internally interconnected within the internal fiber shuffle sub-assembly of upper level shuffle US2T;

FIGS. 30a-e are charts that provide the example internal fiber cross connections within the internal fiber shuffle sub-assembly as it relates to US2T;

FIG. 31a is a perspective view depiction of an embodiment of an upper level shuffle (e.g. US3T);

FIG. 31b is a photo showing a perspective view of the embodiment of the upper level shuffle as shown in FIG. 31a with the lid removed;

FIG. 31c is a front elevation view depiction of the embodiment of the upper level shuffle as shown in FIG. 31a;

FIG. 32 depicts a representation of the fibers that are internally interconnected within the internal fiber shuffle sub-assembly of upper level shuffle US3T;

FIGS. 33a-e are charts that provide the example internal fiber cross connections within the internal fiber shuffle sub-assembly as it relates to US3T;

FIG. 34 is a diagram depicting a set of 12 lower level shuffles (LS24T) connected in a (4×3×2)×3×2×2 torus configuration;

FIG. 35 is a diagram providing an example representation of how an upper level shuffle group (US2T) may be used to form a k=2 loop between lower level shuffles (LS24T #1 and #2), and how an upper level shuffle group (US3T) may be used to form a k=3 loop between lower level shuffles (LS24T #2, #3 and #4);

FIG. 36 is a photo showing how in one embodiment a LS24T, US2T, and US3T shuffle may be located within a rack;

FIG. 37 displays one embodiment of possible connections between shuffle configurations to implement a 48 node direct interconnect network;

FIG. 38 displays one embodiment of possible connections between shuffle configurations to implement a 72 node direct interconnect network;

FIG. 39 displays one embodiment of possible connections between shuffle configurations to implement a 96 node direct interconnect network;

FIG. 40 displays one embodiment of possible connections between shuffle configurations to implement a 144 node direct interconnect network;

FIG. 41 displays another embodiment of possible connections between shuffle configurations to implement a 144 node direct interconnect network;

FIG. 42 displays one embodiment of possible connections between shuffle configurations to implement a 192 node direct interconnect network;

FIG. 43 displays one embodiment of possible connections between shuffle configurations to implement a 288 node direct interconnect network;

FIG. 44 displays another embodiment of possible connections between shuffle configurations to implement a 288 node direct interconnect network;

FIG. 45 displays yet another embodiment of possible connections between shuffle configurations to implement a 288 node direct interconnect network;

FIG. 46a is a perspective view depiction of various embodiments of upper level shuffles, including US4T;

FIGS. 46b-i are charts that provide the example internal fiber cross connections within the internal fiber shuffle sub-assembly as it relates to US4T;

FIG. 46j is a depiction of an embodiment of an upper level shuffle (US4T) connected to lower level shuffles (LS24T);

FIG. 46k is a depiction of the use of revised R-keys in an upper level shuffle (US4T) to reduce the number of ring groups;

FIG. 46l is a chart of the internal wiring for a revised upper shuffle R-key;

FIG. 47a displays a perspective view of a shuffle embodiment that provides connections between nodes or clients connected to the xA ports to devices or peripheral components connected to the xB ports;

FIG. 47b displays a front view of the shuffle embodiment at FIG. 47a that provides connections between nodes or clients connected to the xA ports to devices or peripheral components connected to the xB ports;

FIG. 48a displays a perspective view of another shuffle embodiment that provides connections between nodes or clients connected to the xA ports to devices or peripheral components connected to the xB ports;

FIG. 48b displays a front view of the shuffle embodiment at FIG. 48a that provides connections between nodes or clients connected to the xA ports to devices or peripheral components connected to the xB ports;

FIG. 48c displays a top view (cover removed) of the shuffle embodiment at FIG. 48a that provides connections between nodes or clients connected to the xA ports to devices or peripheral components connected to the xB ports;

FIG. 48d displays an example internal shuffle cable embodiment with fiber mapping that may be used to make the necessary connections between the xA and xB ports of the shuffle embodiment at FIG. 48a;

FIG. 49a displays a 4:1 optical cable for multiple node or client connection to a port; and

FIG. 49b displays the example fiber mapping that may be used to provide connectivity for the 4:1 optical cable of FIG. 49a.

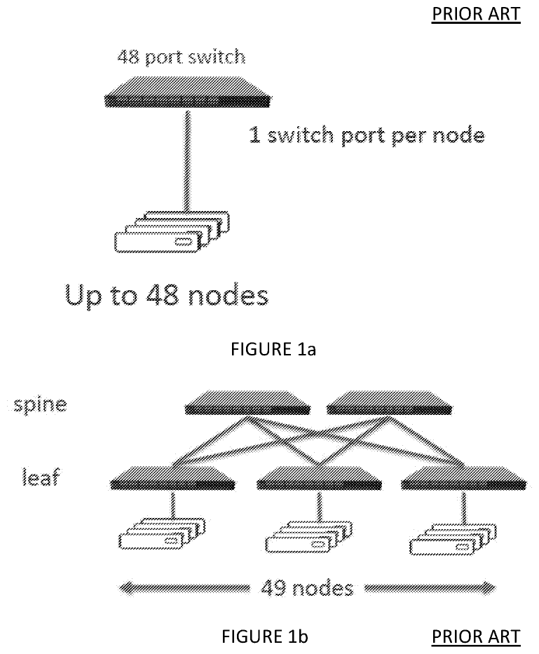

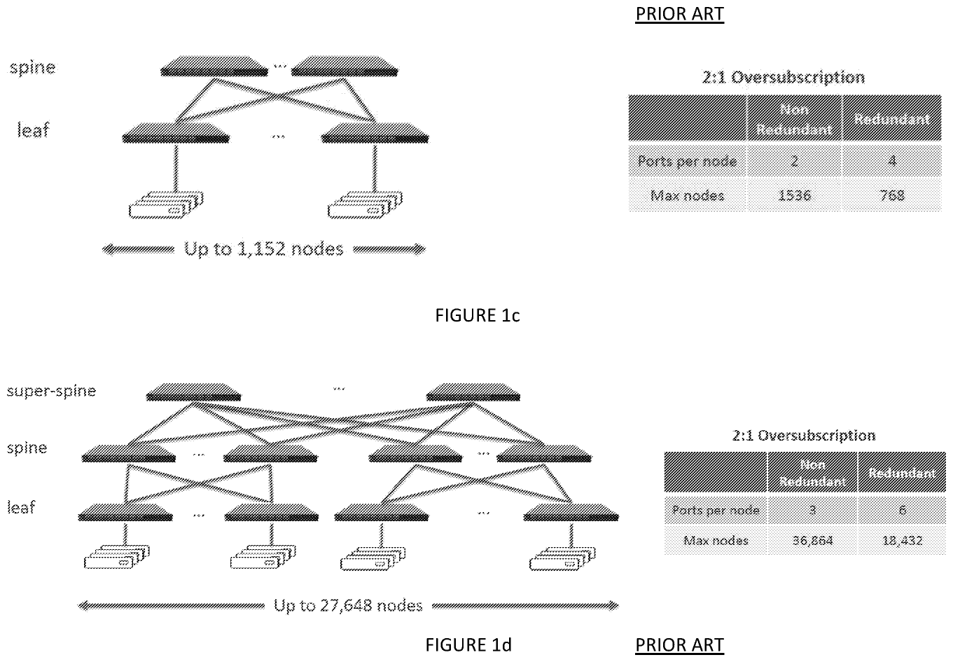

### DETAILED DESCRIPTION OF THE INVENTION

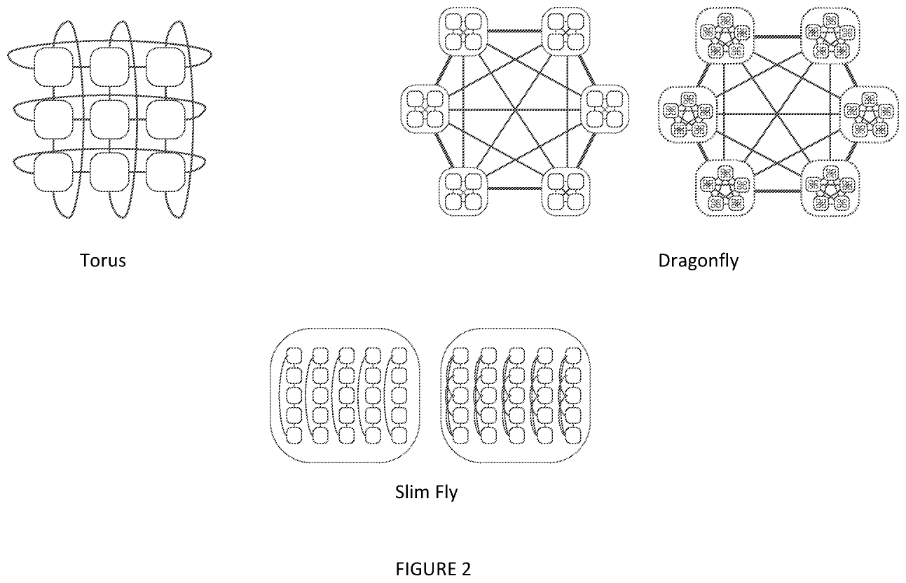

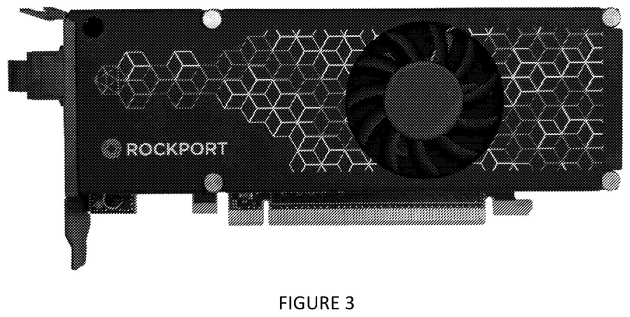

The various shuffles of the present invention are passive optical interconnect devices. These non-electric devices are capable of providing the direct interconnection of nodes or clients in various topologies as desired (including torus, dragonfly, slim fly, and other higher radix topologies for instance; see example topology representations at FIG. 2), and assist in optimizing networks by moving the switching function to the endpoints. In a torus configuration, for instance, each node or client will occupy a connector in a node port of a lower level shuffle, and in the case where a node port is not populated with a connection to a node or client, a special first-type or primary R-key is instead connected to the available node port in order to maintain inline connections for proper connectivity. The nodes or clients may potentially be any number of different devices, including but not limited to processing units, memory modules, I/O modules, PCIe cards, network interface cards (NICs), PCs, laptops, mobile phones, servers (e.g. application servers, database servers, file servers, game servers, web servers, etc.), or any other device that is capable of creating, receiving, or transmitting information over a network. As an example, in one preferred embodiment, the node may be a network card, such as the Rockport R06100 Network Card, a photo of which is provided at FIG. 3. Such network cards are installed in servers, but use no server resources (CPU, memory, and storage) other than power, and appear to be an industry-standard Ethernet NIC to the Linux operating system. Each Rockport R06100 Network Card supports an embedded 400 Gbps switch (twelve 25 Gbps network links; 100 Gbps host bandwidth) and contains software that implements the switchless network over the shuffle topology. The Rockport R06100 Network Cards connect to a lower level shuffle at node ports via an optical MTP® (Multi-fiber Pull Off) connector (24-fiber) through an OM4, low loss, polarity A cable, with female ends. This 24-fiber cable supports links and 6 dimensions.

The lower level shuffles also comprise trunk ports that do not directly connect to nodes or clients, but that instead allow connection to upper level shuffle(s) in order to grow network structures in an optimal manner, including in increased dimensions. Trunk ports that are not populated with a connection to an upper level shuffle are preferably populated with a different, special second-type or secondary R-key to provide enhanced connectivity by creating cut through paths or short cut links in the mesh topology.

The present invention will be described in relation to certain non-limiting examples of shuffles and how they can be implemented to interconnect nodes or clients, e.g. Rockport R06100 Network Cards, in order to provide a detailed enabling disclosure for skilled persons. The teaching of these embodiments will allow the skilled person to implement any number of different embodiments or configurations of shuffles that are capable of supporting a smaller or much larger number of interconnected nodes or clients in various topologies, whatever such nodes or clients may be, as desired.

As noted above, the shuffles provide the optical paths for the implementation of direct interconnect links within the network fabric, but the topology complexity is hidden from end users. These shuffles provide a passive optical shuffle function to enable simple connectivity to node assemblies (e.g. to a Rockport R06100 Network Card via a single fiber optic cable). The shuffle is predefined to interconnect between multiple shuffle ports each comprising a connector, with different links between different shuffle ports, i.e. they are not a direct inline path, as a connector will splay out its optical connections to multiple other shuffle connectors in a predefined configuration.

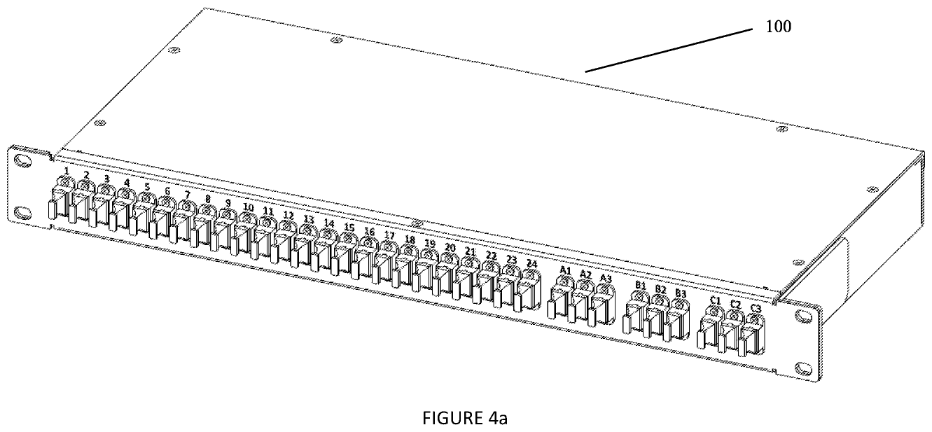

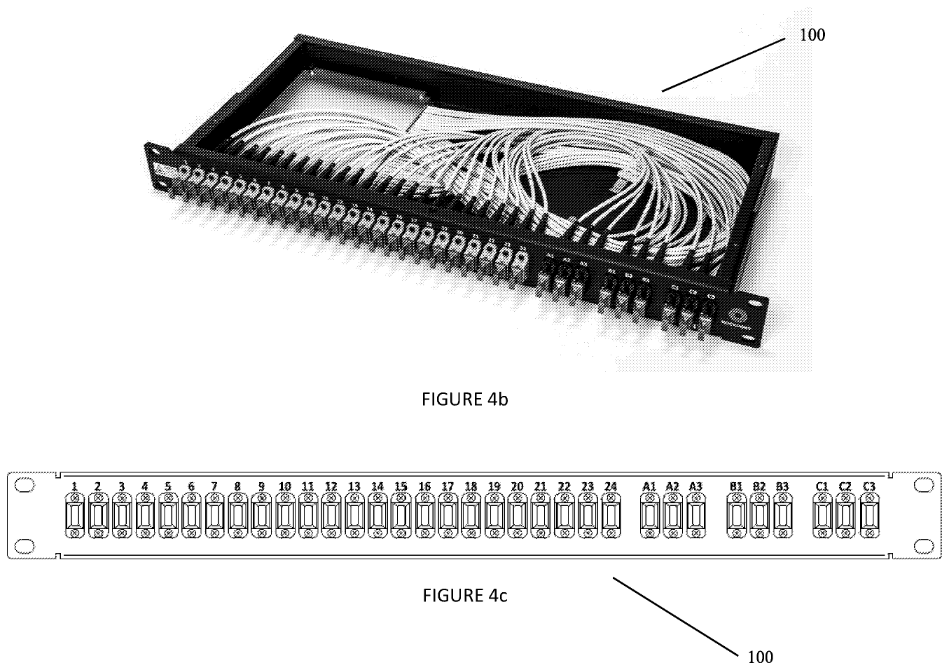

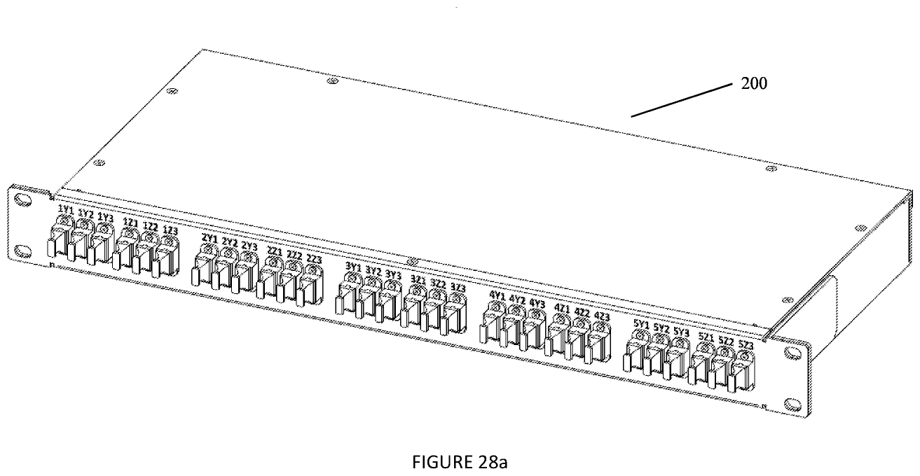

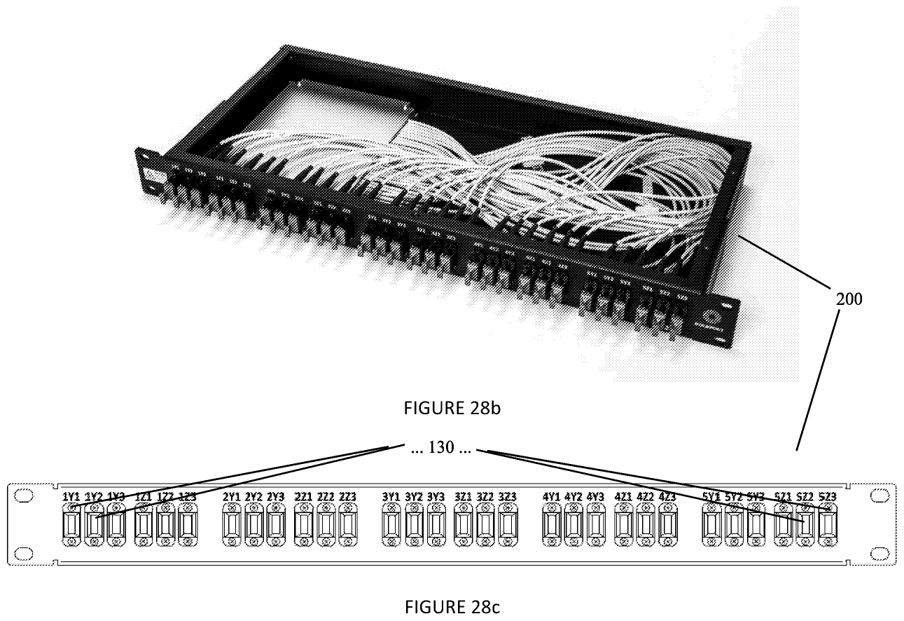

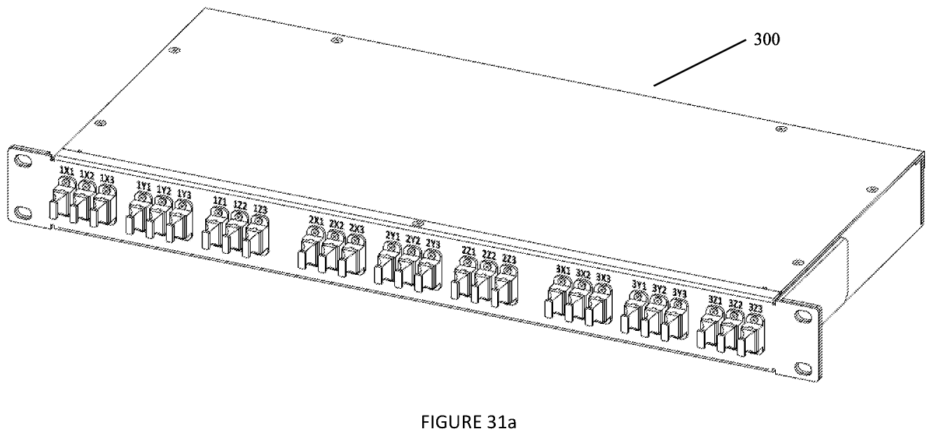

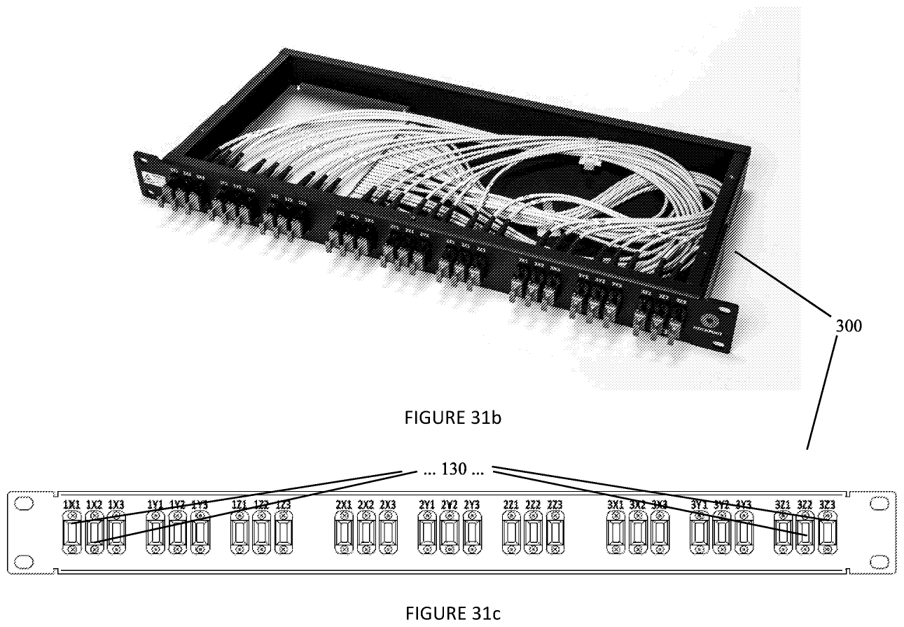

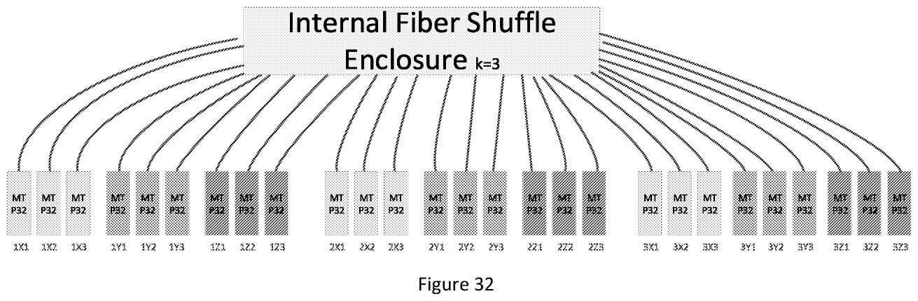

In a preferred embodiment, three example variants of shuffle embodiments that support different network configurations are described herein, namely a lower level shuffle 100 as shown in FIGS. 4a-c (an example of which is referred to herein as “LS24T” due to its configuration in one embodiment), an upper level shuffle 200 as shown in FIGS. 28a-c (an example of which is referred to herein as “US2T” due to its configuration in one embodiment), and another variant of the upper level shuffle 300 as shown in FIGS. 31a-c (an example of which is referred to herein as “US3T” due to its configuration in one embodiment). Each of these variants or embodiments of shuffles, as will be described more fully herein, have internal connections that assist with the implementation of a torus interconnect. However, as noted above, a skilled person would understand how to create shuffles that implement other topologies, such as dragonfly, slim fly, and other higher radix topologies, based on the teachings herein. Moreover, a skilled person would understand how to create shuffles that internally interconnect differing numbers of nodes or clients as desired for a particular implementation, e.g. shuffles that can interconnect 8, 16, 24, 48, 96, etc. nodes or clients.

Each shuffle embodiment 100, 200, 300 mentioned above would generally sit in different locations within the direct interconnect network, but all embodiments of shuffles are preferably designed to fit within a 1U rack mountable configuration for ease of use in a network environment comprising standard 19-inch server racks. This, however, is not a requirement as some skilled persons may wish to implement shuffles that contain a larger number of ports, and may therefore require an assembly>1U. In a preferred embodiment, the shuffles have mounting flanges on either end of the faceplate containing apertures as locations for mounting to the rack. Of course, the shuffles are preferably modular and could be manufactured to support side of rack configurations and enclosures other than 19-inches.

The example 24-port lower level shuffle 100 (e.g. LS24T), as shown in FIGS. 4a-c (shown with dust covers over the connectors), is based upon a monolithic shuffle assembly (all ports shuffled within one assembly), and is the shuffle that will directly connect to the nodes or clients 50 (i.e. in this example, up to 24 Rockport R06100 Network Cards) that will be interconnected in the shuffle assembly. The shorthand term “LS24T” in this embodiment is a reference to a “lower level shuffle” that can interconnect up to “24” nodes in a “torus” structure. As noted above, a skilled person would understand that the nodes or clients 50 may potentially comprise any number of different devices, including but not limited to processing units, memory modules, 110 modules, network cards, PCIe cards, network interface cards (NICs), PCs, laptops, mobile phones, servers (e.g. application servers, database servers, file servers, game servers, web servers, etc.), or any other device that is capable of creating, receiving, or transmitting information over a network.

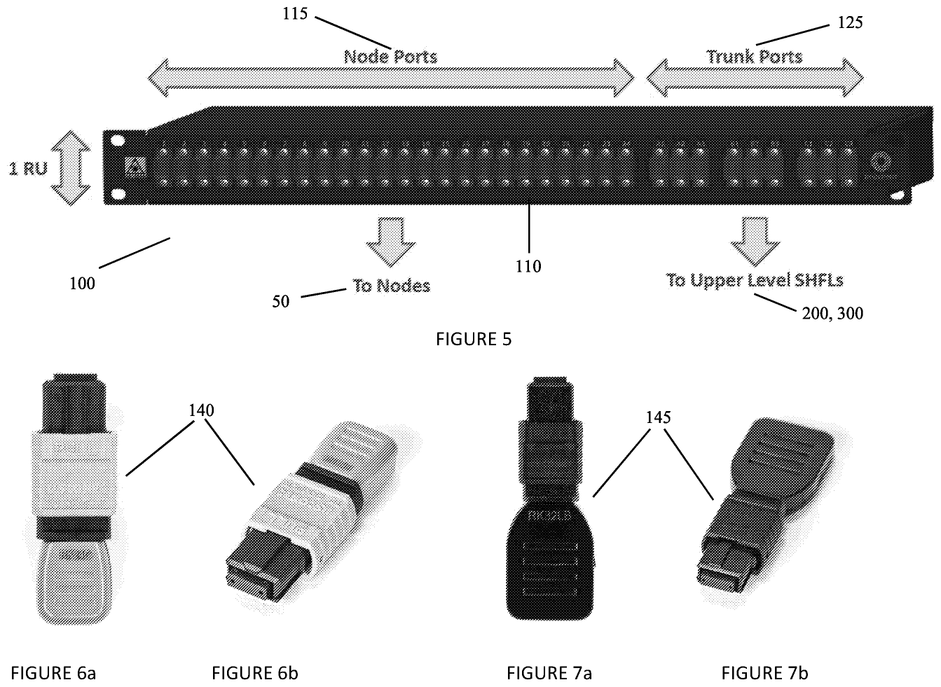

With reference to the representation at FIG. 5, externally the shuffle 100 has a faceplate 110 that exposes 24 node ports 115 and 9 trunk ports 125. The 24 node ports 115 are either externally connected to nodes or clients 50 that will be interconnected (e.g. network cards) or are otherwise populated by first-type or primary R-keys ((e.g. MTP®/MPO-24 (meaning Multi-fiber Pull Off/Multi-fiber Push On) fiber R-keys) 140; see FIGS. 6a and 6b which display MTP®-24 fiber R-keys) to maintain inline connections (described below). The 9 trunk ports 125 are either externally connected to upper level shuffles 200, 300 for network or dimension expansion (and not to nodes or clients 50 or other lower level shuffles 100) or may otherwise preferably be populated by second-type or secondary R-keys (e.g. MTP®/MPO-32 fiber R-keys 145; see FIGS. 7a and 7b which display MTP®-32 fiber R-keys) for “enhanced connectivity” (described further below).

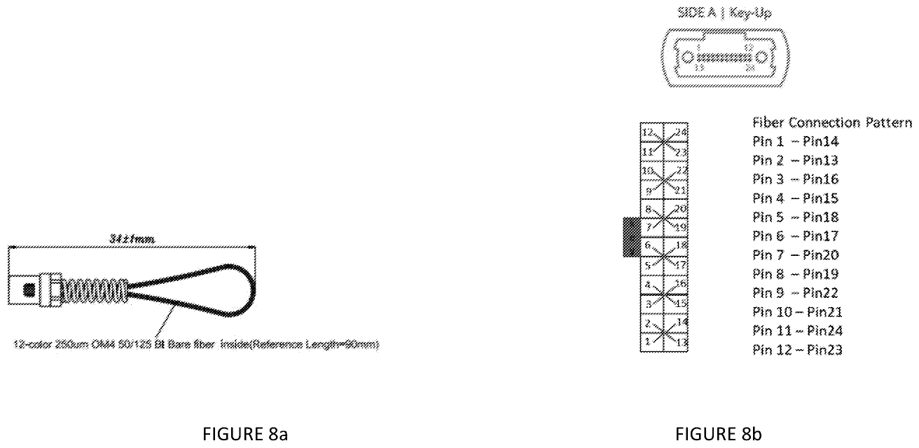

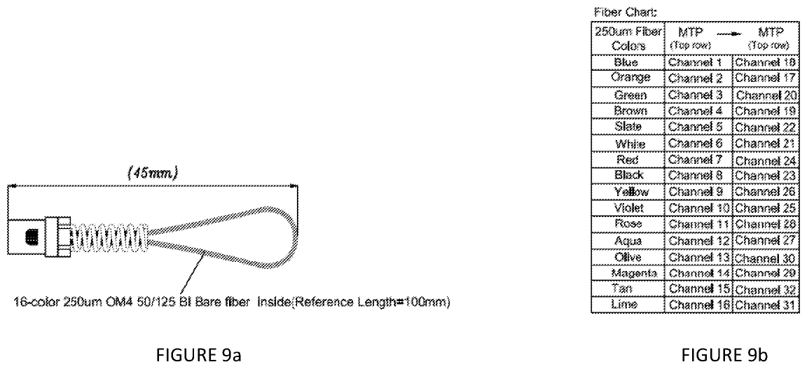

R-keys are essentially used to link fibers from one node to another within the confines of the shuffle 100. To accomplish this, the R-keys are generally configured to connect transmit fibers of one channel to receive fibers of its second channel. The MTP®/MPO-24 fiber R-keys 140 employ a fiber loop (as shown in FIG. 8a), which is preferably designed to minimize optical loss, and FIG. 8b shows a representation of its internal connections. The MTP®/MPO-32 fiber R-keys 145 also employ a fiber loop (as shown in FIG. 9a), which again is preferably designed to minimize optical loss, and FIG. 9b shows a representation of its internal connections. The fiber channels and fiber cross-connects in the R-keys 140, 145 will be better understood in view of details provided further below.

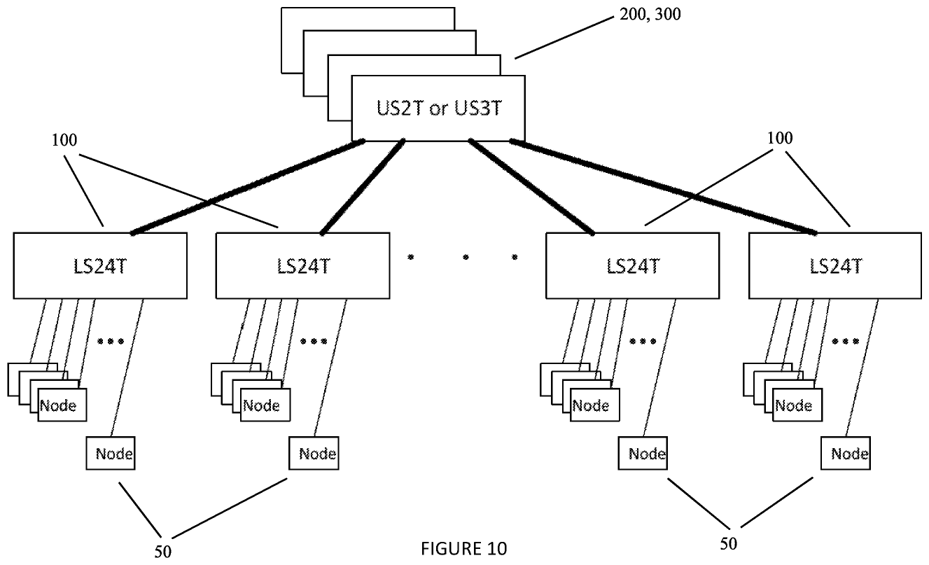

The LS24T lower level shuffle 100 embodiment implements a 3-dimensional torus-like structure in a 4×3×2 configuration when 24 nodes or clients 50 are connected to the 24 node ports 115. Dimensions 1, 2, and 3 are thereby closed within the shuffle 100, and dimensions 4, 5, and 6 are made available via connection to upper level shuffles 200, 300 through the trunk ports 125. FIG. 10 provides a representative shuffle connectivity diagram to assist with an initial understanding of how network growth may be implemented using the example shuffle embodiments.

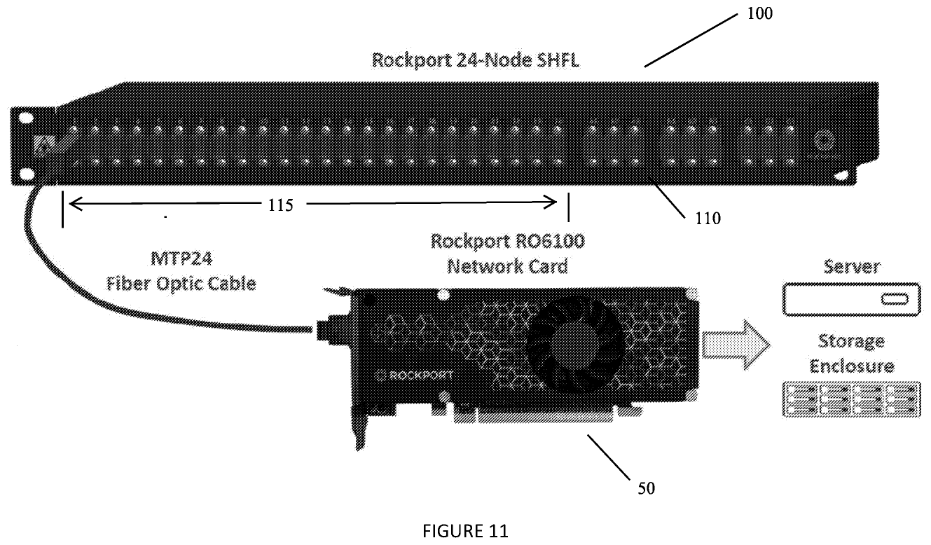

In order to build out the interconnect network (when shuffle 100 has a preferred internal wiring design, as will be described in detail below), a user will simply populate the node ports 115 from left to right across the faceplate 110 with connections to nodes or clients 50 as shown in FIG. 11, removing the MTP®/MPO-24 fiber R-keys 140 as they progress (i.e. the R-keys 140 remain in place in the node ports 115 of lower level shuffle 100 unless and until a node or client 50 is to be added to the network in a sequential manner). This allows the torus structure (in this example) to be built in an optimal manner, ensuring that as the torus is built up it is done with a minimum/optimal set of optical connections between nodes or clients 50 and no/minimal open fiber gaps between nodes or clients 50 (to maximize performance). Specifically, connecting nodes or clients 50 from left to right across the faceplate 110 builds the torus logically from a 2×2×2 configuration to a 3×3×2 configuration to a 4×3×2 configuration. There is no practical minimal limit on how many nodes or clients 50 are required to create an interconnect, but 8 nodes are required to create a 2×2×2 torus configuration.

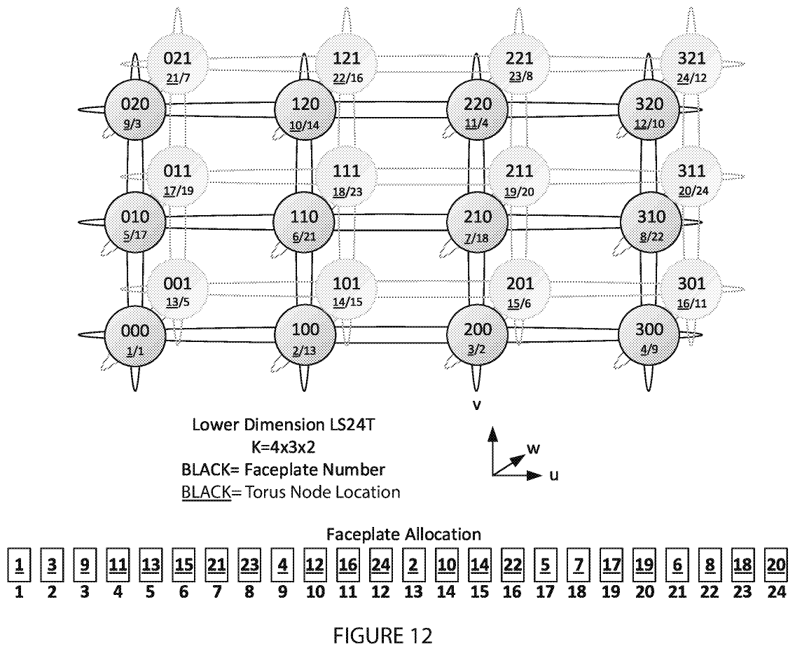

Such an optimal build out can be explained with reference to FIG. 12, which displays a representative 4×3×2 torus configuration (having u,v,w coordinates). The numbers below the boxes in the “Faceplate Allocation” represent the 24 node ports 115 numbered sequentially on the faceplate 110 of shuffle 100, while the numbers that are underlined within the boxes represent the node or client location within the notional torus structure as depicted. Thus, when the MTP®/MPO-24 fiber R-key 140 at node port #1 of node ports 115 is replaced with a connection to a node or client 50, the node or client 50 is added to node location #1 (0,0,0) within the torus structure. When the MTP®/MPO-24 fiber R-key 140 at node port #2 of node ports 115 is replaced with a connection to another node or client 50, the node or client 50 is added to node location #3 (2,0,0) within the torus structure. When the MTP®/MPO-24 fiber R-key 140 at node port #3 of node ports 115 is replaced with a connection to yet another node or client 50, the node or client 50 is added to node location #9 (0,2,0) within the torus structure, etc. This process may continue in accordance with FIG. 12 until all 24 node ports 115 are sequentially connected from left to right across the faceplate 110 with connections to nodes or clients 50. As each node or client 50 is added to each node port 115, the wiring of the shuffle 100 ensures that it is placed at an optimal location within the torus to maximize the performance of the resulting topology. For a torus, a balanced topology with each dimension having the same number of nodes provides maximum performance. Thus, the shuffle 100 is wired to create a topology that is as close to balanced as possible for the number of nodes or clients 50 connected to the shuffle. It is thus the desired build out of the direct interconnect structure as nodes or clients 50 are added to the network that dictates how the shuffle 100 should be internally wired to interconnect the nodes or clients 50 (discussed in detail below).

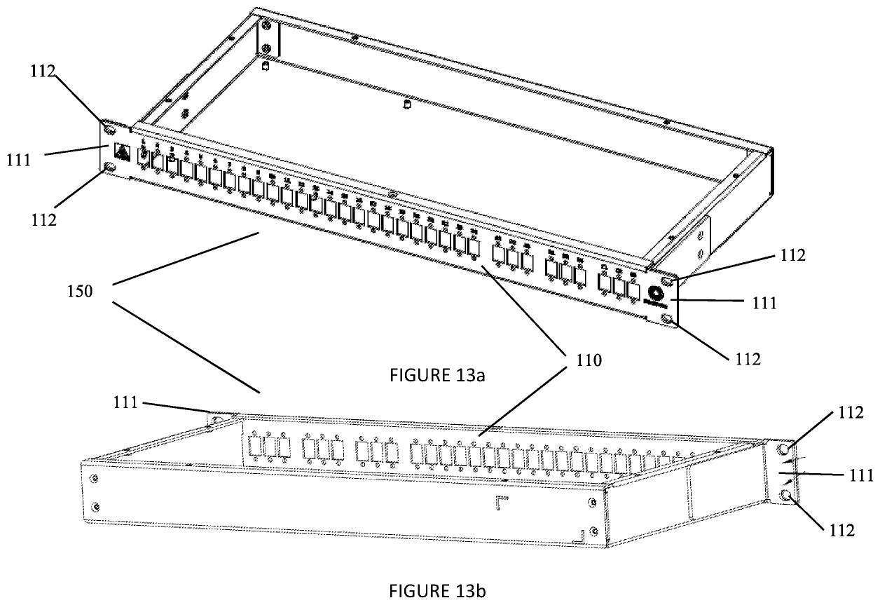

We will now provide details that will allow the skilled person to construct a shuffle 100 and the wire interconnections therein, with specific reference to the design of lower level shuffle 100 (LS24T). FIGS. 13a and 13b depict front and rear perspective views of an example bottom chassis 150 from which the lower level shuffle 100 (LS24T) is configured in accordance with one embodiment of the present invention. Similar chassis would be used for upper level shuffles 200, 300. As noted above, the chassis 150 is preferably designed to fit within a 1U rack mountable configuration for ease of use in a network environment comprising standard 19-inch server racks. However, the chassis 150 is modular and can be manufactured to support side of rack configurations and enclosures other than 19-inches.

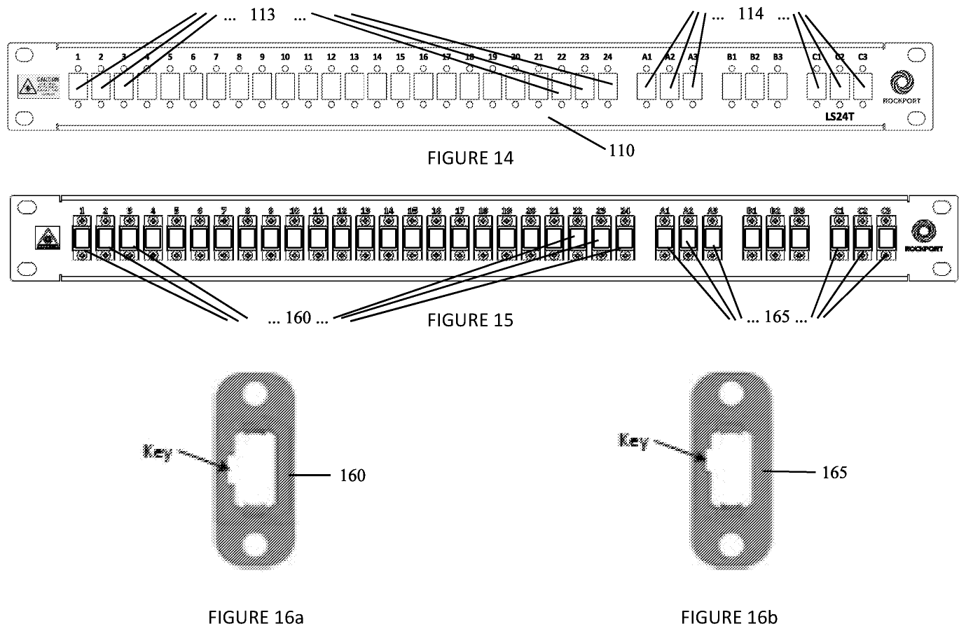

The chassis 150 preferably comprises a faceplate 110 having flanges 111 on either end thereof, and in this non-limiting example has mounting apertures 112 to assist with mounting the shuffle 100 to a rack. Openings 113, 114 on the faceplate 110 of chassis 150, as more easily seen in FIG. 14, will house the 24 node ports 115 and 9 truck ports 125, respectively.

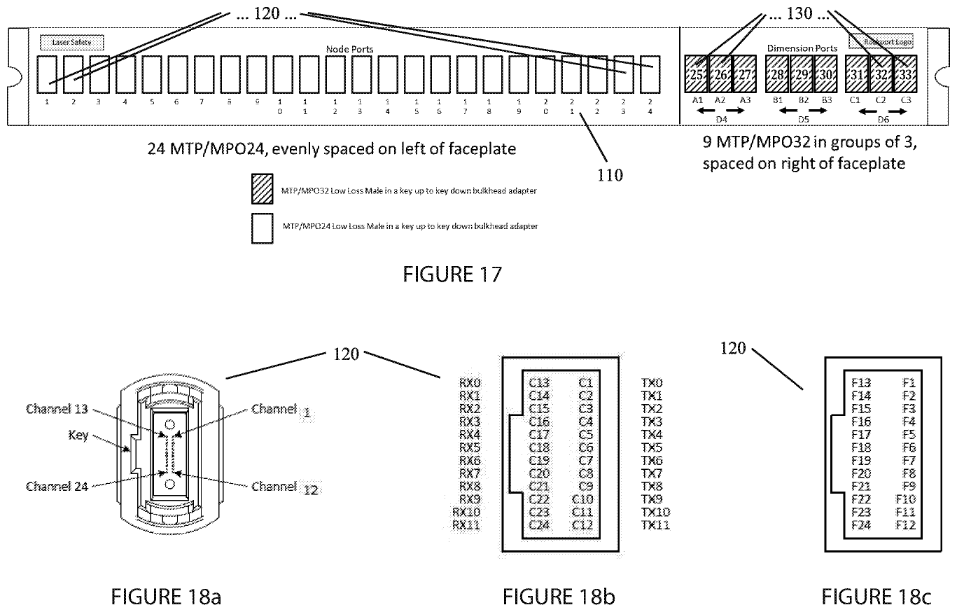

As shown in FIG. 15, first-type or primary bulkhead adapters (e.g. MTP®/MPO-24 keyup/keydown bulkhead adapters 160; see FIG. 16a) are secured to openings 113 on faceplate 110, while second-type or secondary bulkhead adapters (e.g. MTP®/MPO-32 keyup/keydown bulkhead adapters 165; see FIG. 16b) are secured to openings 114 on faceplate 110. The MTP®/MPO-24 bulkhead adapters 160 will securely house first-type or primary optical connectors (e.g. MTP®/MPO-24 (male) low loss optical connectors 120), which provide both internal connections to node port shuffle cables 180 as well as external connections to the nodes or clients 50 (e.g. network cards) or MTP®/1V1P0-24 fiber R-keys 140, as applicable, while the MTP®/MPO-32 bulkhead adapters 165 will securely house second-type or secondary optical connectors (e.g. MTP®/MPO-32 (male) low loss connectors 130), which provide both internal connections to trunk port shuffle cables 185 as well as external connections to upper level shuffles 200, 300 or MTP®/MPO-32 fiber R-keys 145, as applicable, as represented in FIG. 17. FIG. 17 also more explicitly shows the trunk ports 125 (with connectors 130), comprising sub-ports A1-A3, B1-B3, and C1-C3, which may be used to expand the interconnect network into the 4^{th} (D4), 5^{th} (D5), and 6^{th} (D6) dimensions, respectively, by connection to upper level shuffles 200 or 300, as previously discussed.

FIGS. 18a-c show representations of MTP®/MPO-24 (male) low loss optical connectors 120. Looking into the connector at a bulkhead (see FIG. 18a), there are 24 channels (two rows of 12 channels numbered as C1-C12 and C13-C24 as represented in FIG. 18b), each channel housing a fiber. Fibers 1-12 (F1-F12) are transmit fibers located within channels C1-C12, and these fibers may also be referred to as Tx0-Tx11 (see FIGS. 18b and c). Fibers 13-24 (F13-F24) are receive fibers located within channels C13-C24, and these fibers may also be referred to as Rx0-Rx11 (see FIGS. 18b and c).

Together, the transmit and receive channels from each MTP®/MPO-24 connector 120 form links L1-L12. Each link is composed of a single transmit channel and a single receive channel at the same relative location within the MTP®/MPO-24 connector, but on opposite sides. For example, C1 (Tx) and C13 (Rx) form L1, C2 (Tx) and C14 (Rx) form L2, and so forth.

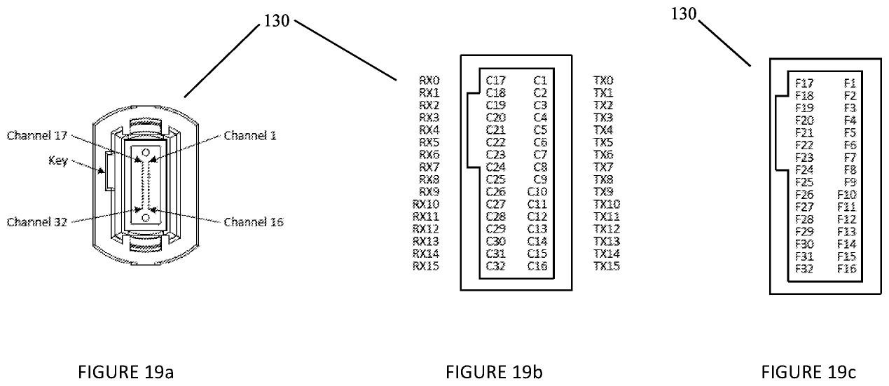

FIGS. 19a-c show representations of MTP®/MPO-32 (male) low loss optical connectors 130. Looking into the connector at a bulkhead (see FIG. 19a), there are 32 channels (two rows of 16 channels numbered as C1-C16 and C17-C32 as represented in FIG. 19b), each channel housing a fiber. Fibers 1-16 (F1-F16) are transmit fibers located within channels C1-C16, and these fibers may also be referred to as Tx0-Tx15 (see FIGS. 19b and c). Fibers 17-32 (F17-F32) are receive fibers located within channels C17-C32, and these fibers may also be referred to as Rx0-Rx15 (see FIGS. 19b and c).

The pinout of the MTP®/MPO-32 based connectors 130 also provides a secondary use for these connectors on the lower level shuffle 100 (LS24T). When the MTP®/MPO-32 based connectors 130 are populated with special MTP®/MPO-32 fiber R-keys 145 (see FIGS. 7a and 7b, and 9a and 9b), it is possible to change the performance of the torus by reducing the number of hops that need to be traversed and increasing the bisectional bandwidth (a concept referred to herein as “enhanced connectivity”) by creating certain cut through paths within the lower level shuffle 100. This is described in detail further below.

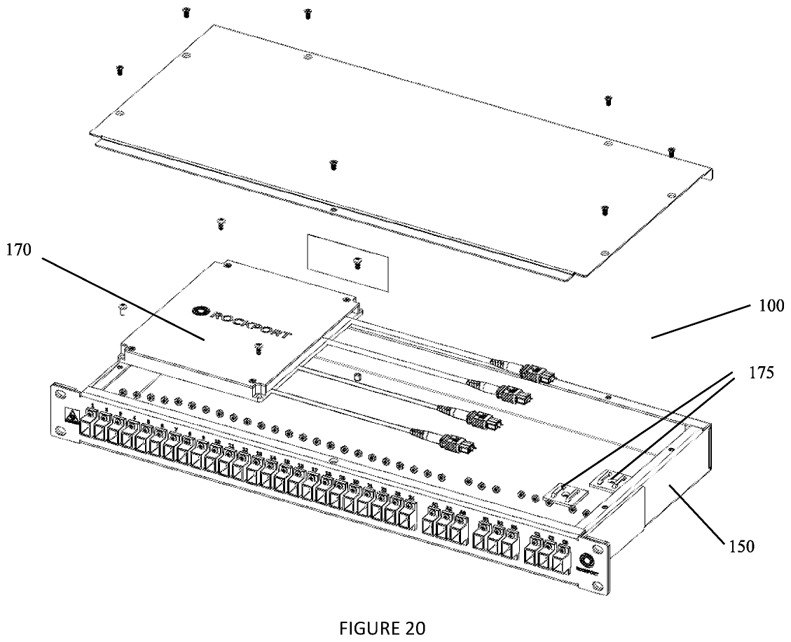

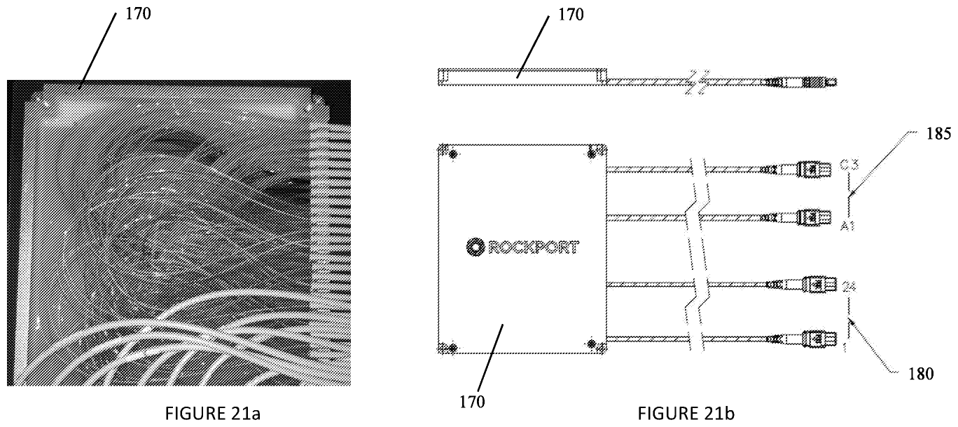

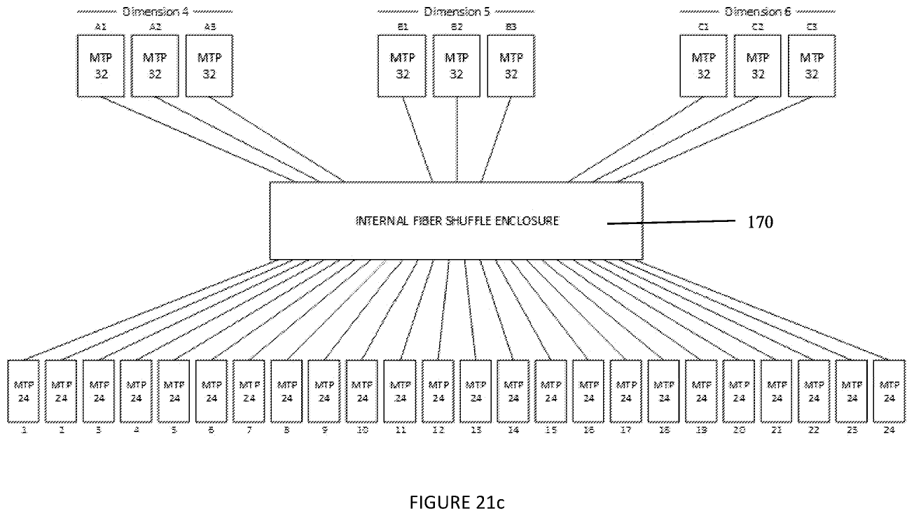

FIG. 20 shows a top perspective view of internal fiber shuffle sub-assembly 170 located in bottom chassis 150 of lower level shuffle 100 (LS24T), along with cable ties 175 for assisting in maintaining cables in an organized manner in the chassis 150. The internal fiber shuffle sub-assembly 170 houses the internal cable shuffle connections for node ports 115 and trunk ports 125 to implement the desired interconnect topology (see, for e.g., the photo at FIG. 21a which shows the fiber cross connect created using a fiber management solution, wherein individual fibers from each incoming port 115, 125 are routed to outgoing fibers). In this embodiment, and with further reference to FIGS. 4b and 21b, the internal fiber shuffle sub-assembly 170 has 24 node port shuffle cables 180 and 9 trunk port shuffle cables 185 extending therefrom (all of which are internally interconnected within sub-assembly 170). The node port shuffle cables 180 preferably comprise 24-fiber OM4 50/1251 μm BI (Bend Insensitive) bare fiber with low loss male ends, surrounded by a 3 mm aqua riser tube, and connect on the internal side of faceplate 110 of shuffle 100 with the MTP®/MPO-24 (male) low loss optical connectors 120 secured into adapters 160 of node ports 115. These cables 180 support links and 6 dimensions. The 9 trunk port shuffle cables 185 preferably comprise 32-fiber OM4 50/1251 μm BI (Bend Insensitive) bare fiber with low loss male ends, surrounded by 3 mm aqua riser tube, and connect on the internal side of faceplate 110 of shuffle 100 with the MTP®/MPO-32 (male) low loss connectors 130 secured into adapters 165 of trunk ports 125. In the present embodiment, both ingress and egress of the fibers is through precision fiber slots with termination on connectors 120, 130. FIG. 21c displays a representation of the fibers that are internally interconnected within internal fiber shuffle sub-assembly 170.

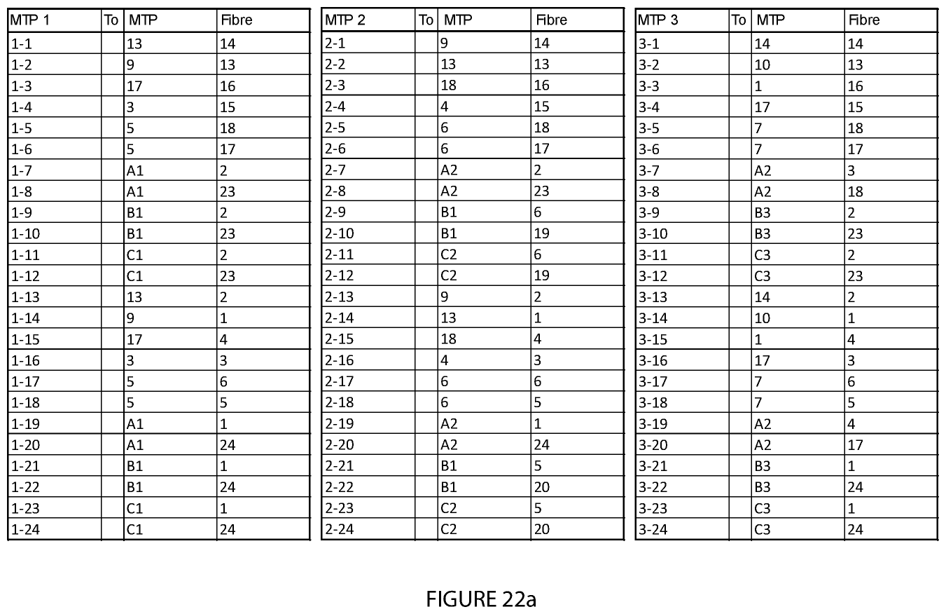

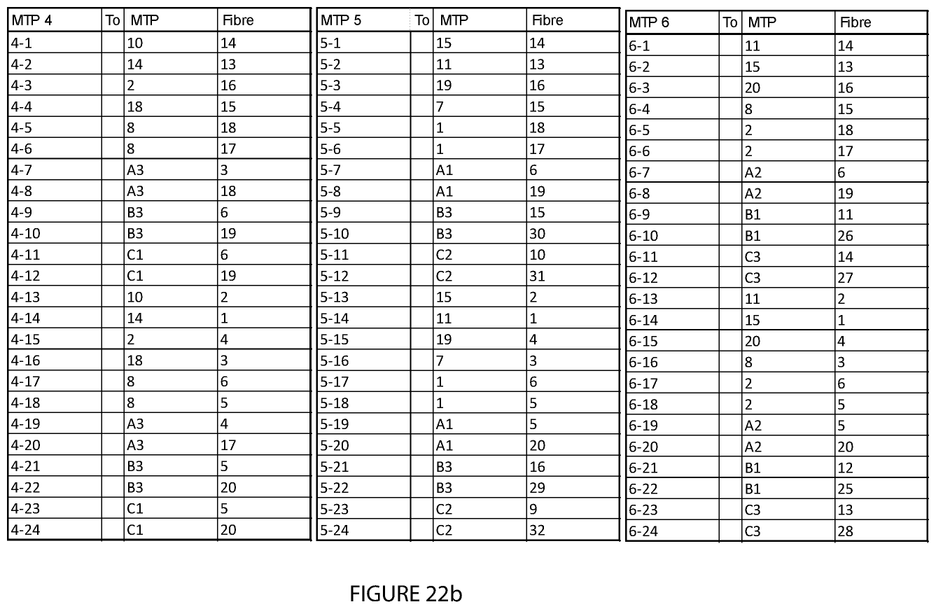

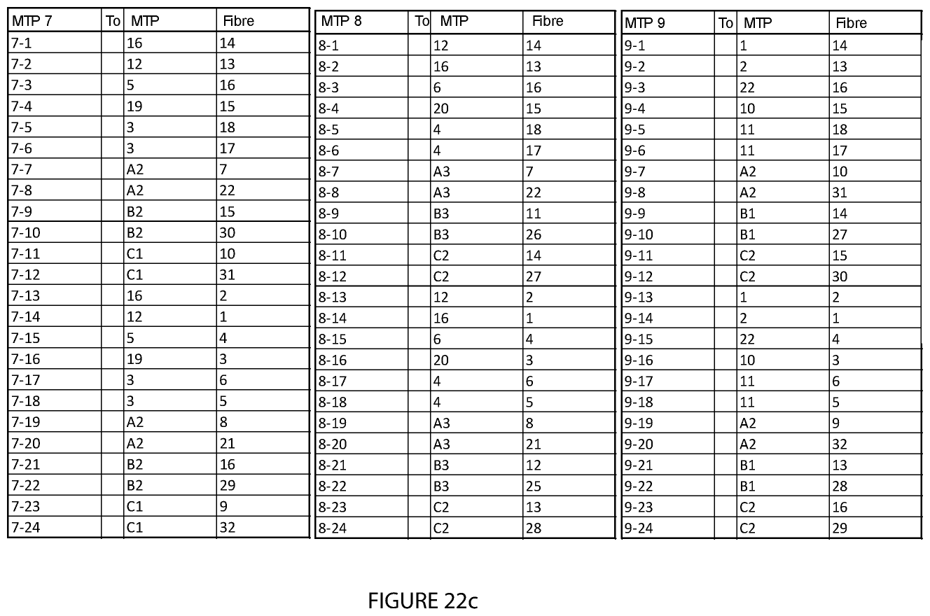

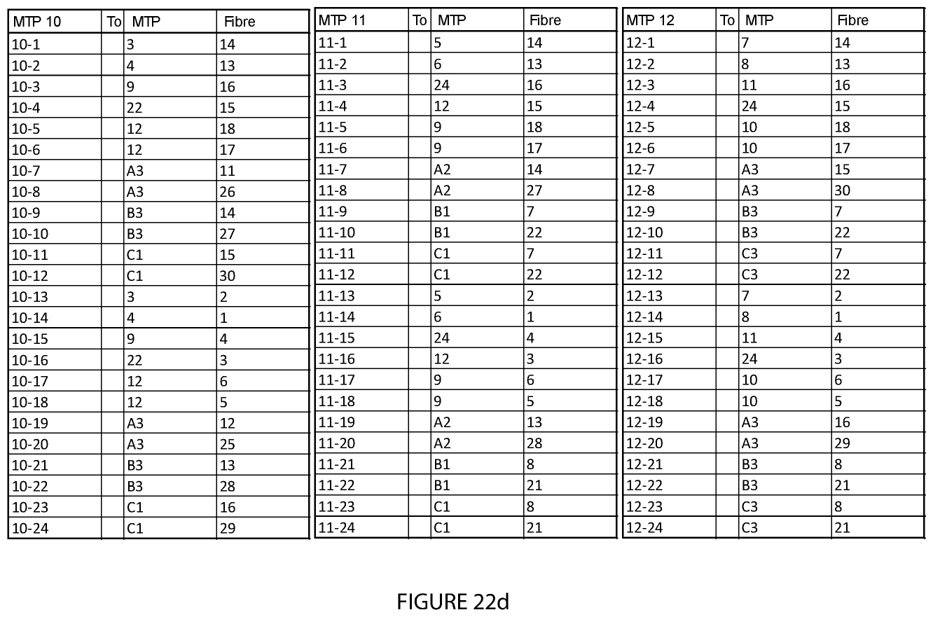

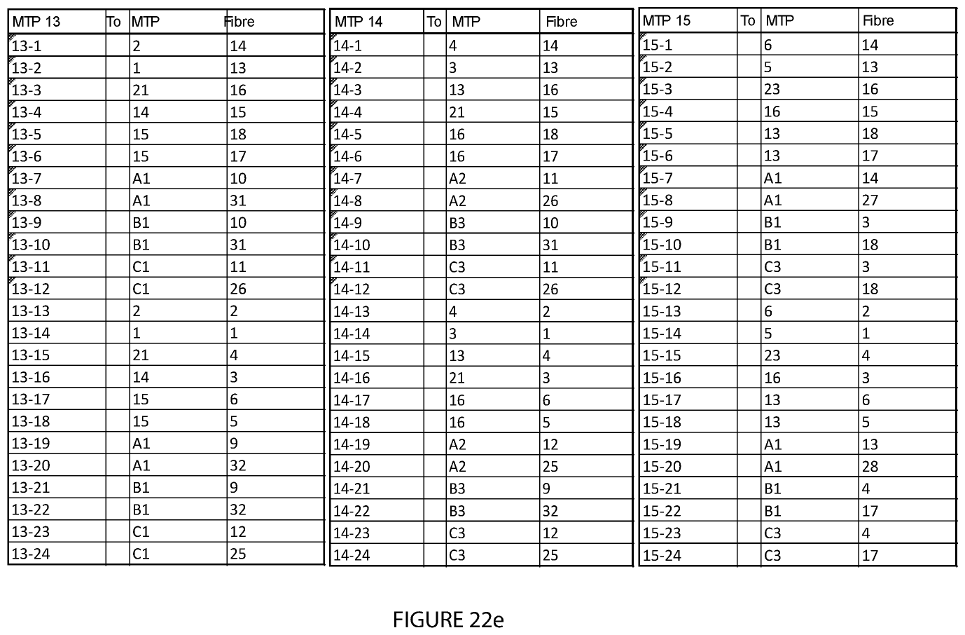

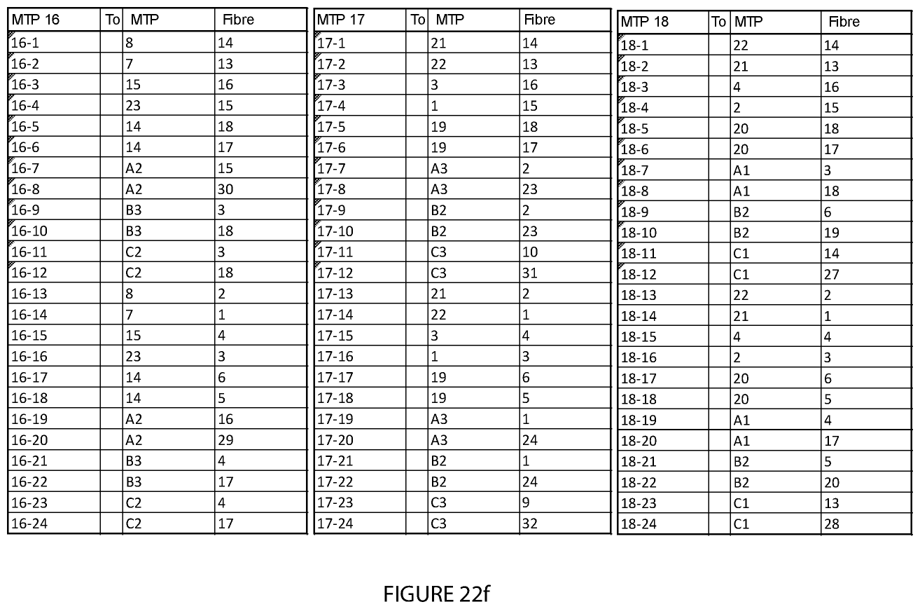

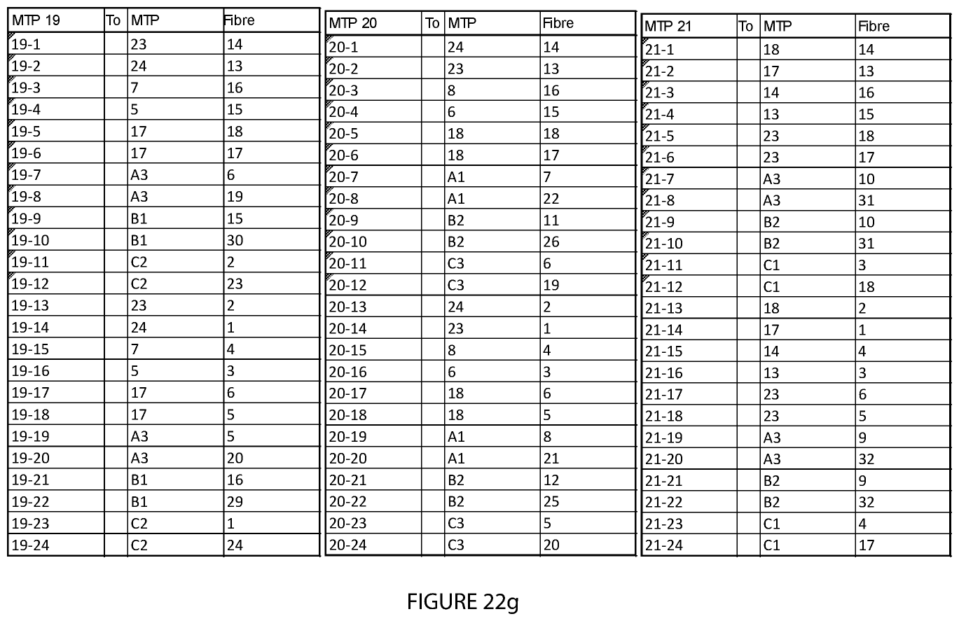

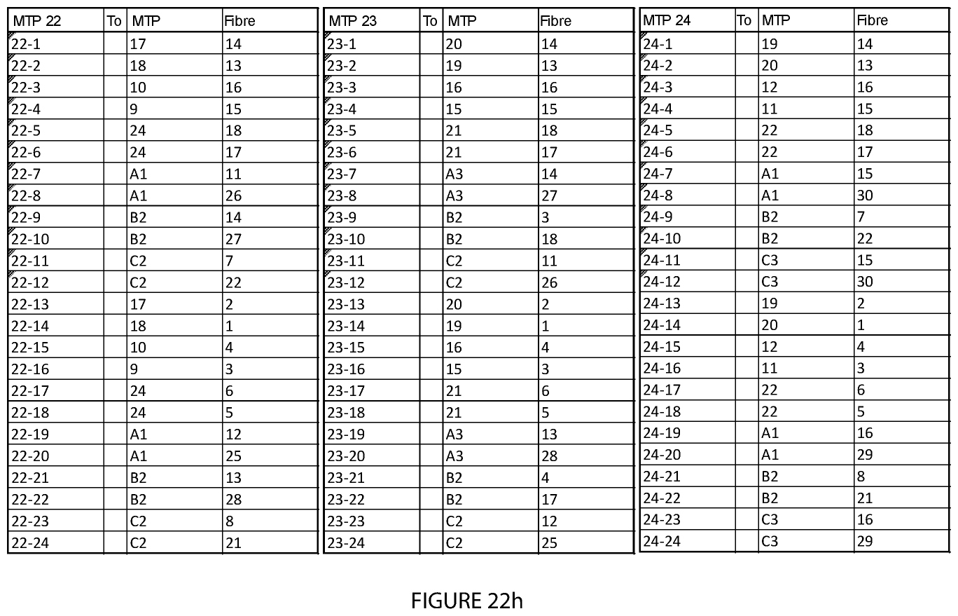

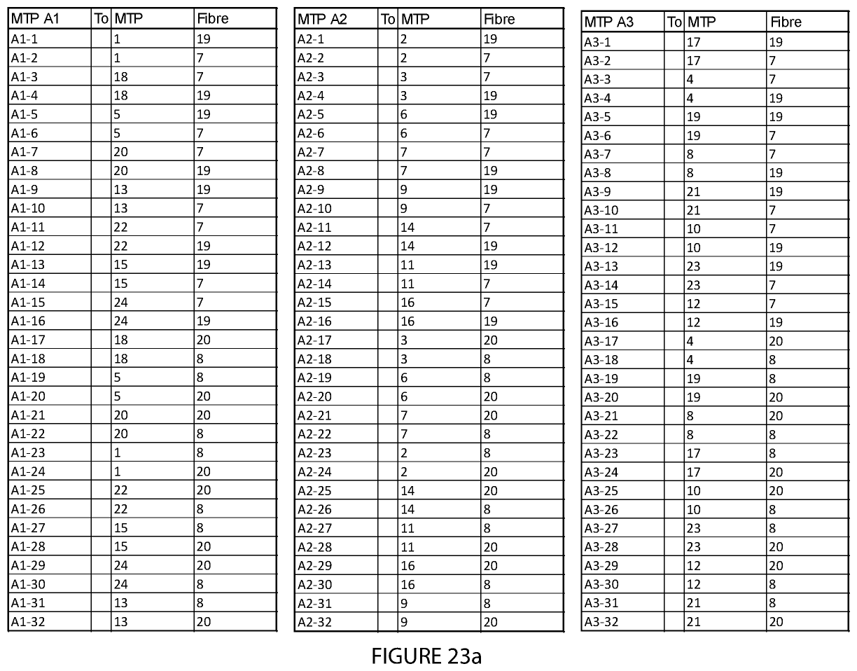

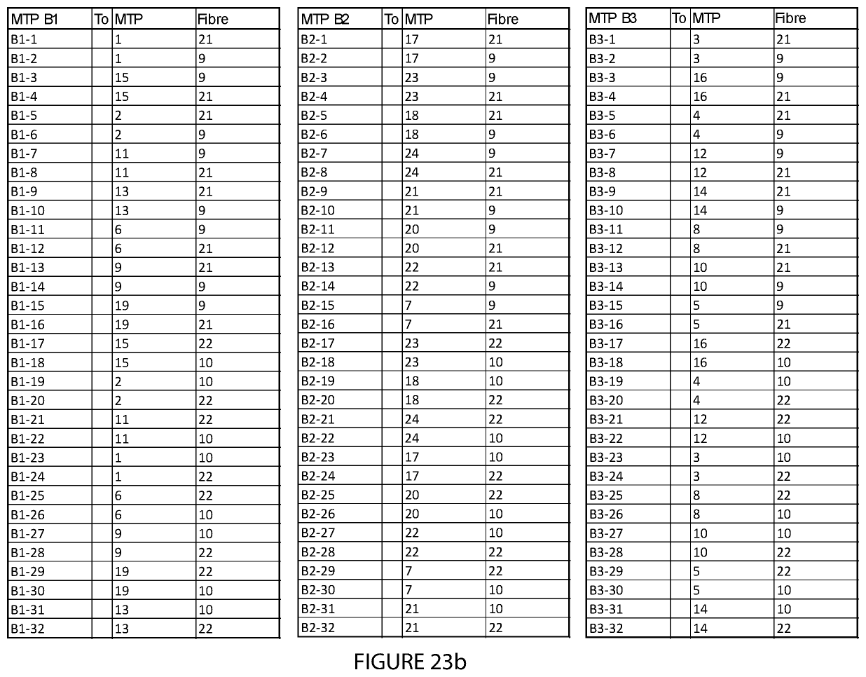

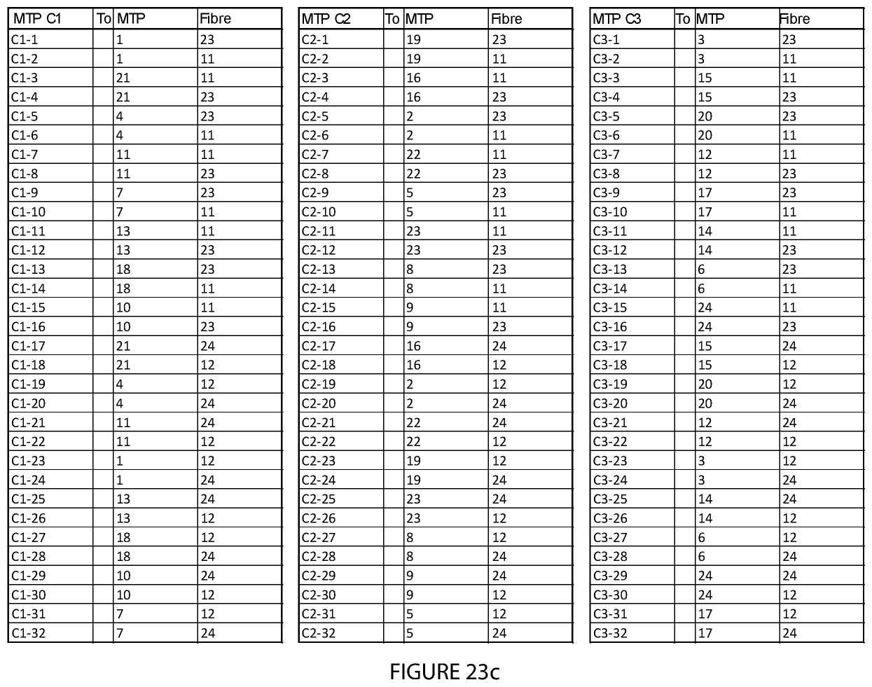

FIGS. 22a-h provide the internal fiber cross connections within internal fiber shuffle sub-assembly 170 as it relates to the 24 node ports 115, while FIGS. 23a-c show the internal fiber cross connections within internal fiber shuffle sub-assembly 170 as it relates to the 9 trunk ports 125 (A1-A3, B1-B3, and C1-C3). The cross connections implement a 3-dimensional torus-like topology in a 4×3×2 configuration. Links L1 and L2 are associated with the torus rings in the “u” dimension, links L3 and L4 are associated with the torus rings in the “v” dimension and links L5 and L6 are associated with the torus rings in the “w” dimension. The remaining links L7-L12 are connected to the 9 trunk ports 125 with L7 and L8 connected to one of trunk ports 125 A1-A3, L9 and L10 connected to one of trunk ports 125 B1-B3, and L11 and L12 connected to one of trunk ports 125 C1-C3. For a proper understanding of the information contained in the charts at FIGS. 22 and 23, as an example, with reference to FIG. 22a (leftmost chart), fiber 1 from connector #1 (i.e. the MTP®/MPO connector 120 at node port #1 of node ports 115 on faceplate 110) is cross connected to fiber 14 on connector #13 (i.e. the MTP®/MPO connector 120 at node port #13 of node ports 115 on faceplate 110). This corresponds to the leftmost chart in FIG. 22e, where you can see that fiber 14 from connector #13 (i.e. the MTP®/MPO connector 120 at node port #13 of node ports 115 on faceplate 110) is cross connected to fiber 1 on connector #1 (i.e. the MTP®/MPO connector 120 at node port #1 of node ports 115 on faceplate 110). Similarly, with reference to FIG. 22b (middle chart), fiber 9 from connector #5 (i.e. the MTP®/MPO connector 120 at node port #5 of node ports 115 on faceplate 110) is cross connected to fiber 15 on connector B3 (i.e. the MTP®/MPO connector 130 at trunk port #6 (or B3) of trunk ports 125 on faceplate 110). This corresponds to the rightmost chart of FIG. 23b, where you can see that fiber 15 on connector B3 (i.e. the MTP®/MPO connector 130 at trunk port #6 (or B3) of trunk ports 125 on faceplate 110) is cross connected to fiber 9 on connector #5 (i.e. the MTP®/MPO connector 120 at node port #5 (of node ports 115) on faceplate 110).

The specific wiring pattern for the internal fiber cross connections can be well understood when the information contained in the charts at FIG. 22 is compared to the information at FIG. 12. As an example, the leftmost chart in FIG. 22a shows that the fibers of MTP®/MPO connector 120 at node port #1 of node ports 115 are connected to fibers at MTP®/MPO connectors 120 at node ports #13, 9, 17, 3, and 5 of node ports 115. As shown in FIG. 12 (and explained above), these node ports correspond to node locations 2, 4, 5, 9, and 13, respectively, in the notional 4×3×2 torus configuration. In other words, the fibers in the various MTP®/MPO connectors 120 of node ports 115 are directly connected to fibers in those other connectors 120 at node ports 115 that correspond to the node locations in the notional torus configuration to which they are directly connected (i.e. those connectors/node locations that are 1 hop/link away). With reference to the charts at FIG. 22, it is also important to note that the various connectors are connected by both transmit and receive fibers for bi-directional transmission. As noted above, it is thus the desired build out of the direct interconnect structure as nodes or clients 50 are added to the network that dictates how the shuffle 100 should be internally wired to interconnect the nodes or clients 50. With this understanding, the skilled person is capable of determining the internal fiber cross connections needed to create other types of torus configurations, as well as those for dragonfly, slim fly, and other higher radix topologies for instance.

As noted above, the charts at FIGS. 22 and 23 also show that fibers from the various MTP®/MPO connectors 120 at node ports 115 are also connected to fibers in various MTP®/MPO connectors 130 at trunk ports 125. This is for the purpose of creating “enhanced connectivity” when the MTP®/MPO connectors 130 are populated by MTP®/MPO-32 fiber R-keys 145, or for network or dimension expansion when the MTP®/MPO connectors 130 are instead connected to an upper level shuffle(s) 200, 300.

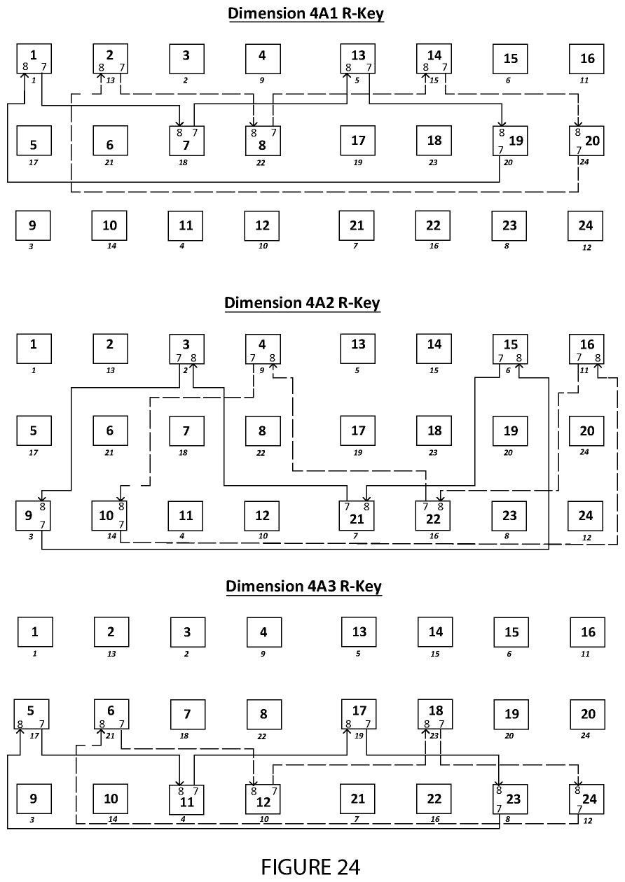

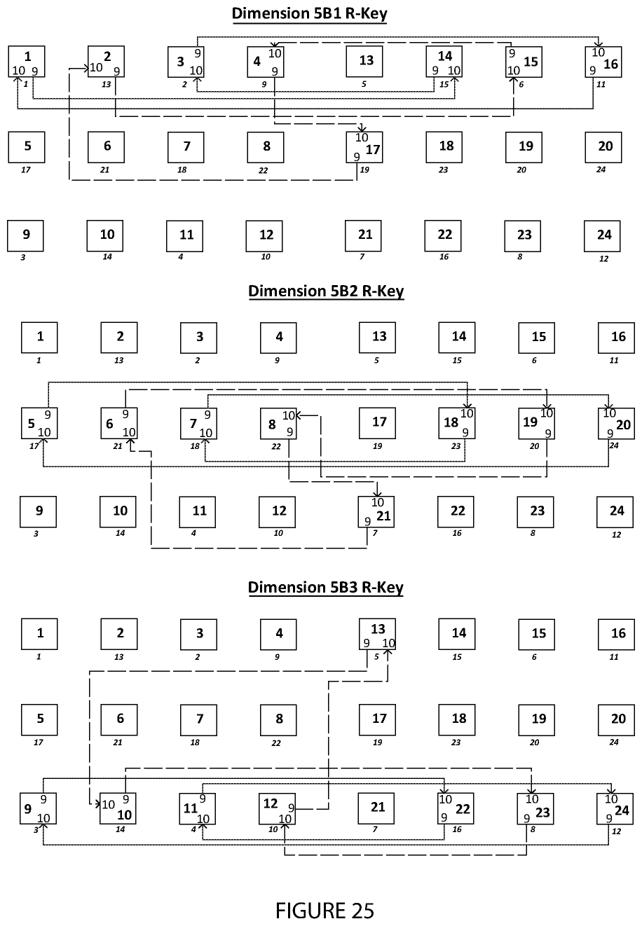

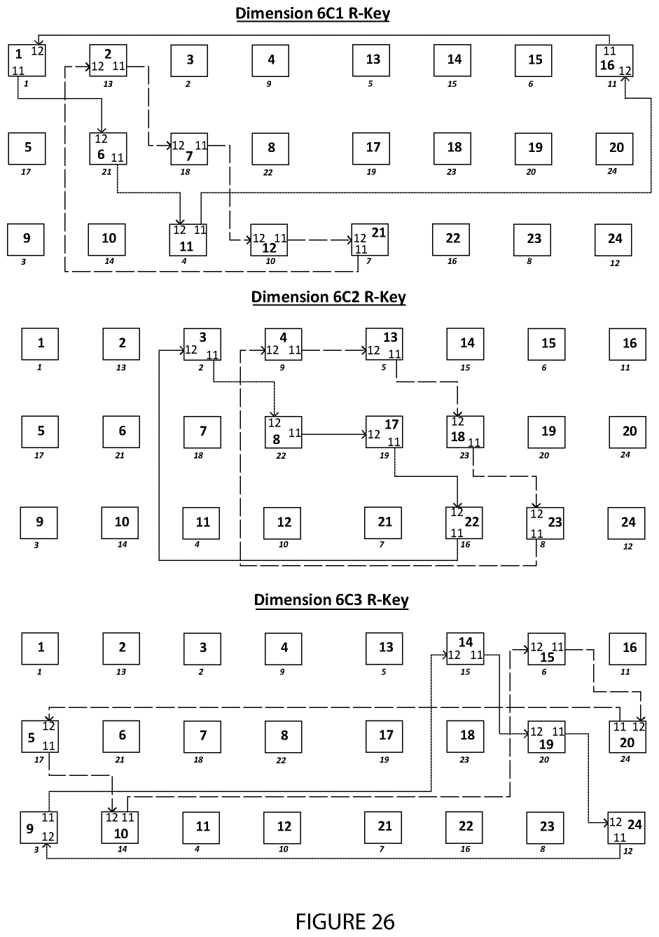

The MTP®/MPO-32 based connectors 130 (for dimensions 4, 5, and 6) are wired such that when they are populated by the special MTP®/MPO-32 R-keys 145 they reduce the number of hops that need to be traversed and increase the bisectional bandwidth in the torus mesh (“enhanced connectivity”) by creating cut through paths or short cut links within the fabric (more specifically, by creating offset rings). FIGS. 24, 25, and 26 show the additional interconnect on shuffle 100 (LS24T) when the MTP®/MPO-32 fiber R-keys 145 are installed in the A1-A3 (4^{th} dimension), B1-B3 (5^{th} dimension), and C1-C3 (6^{th} dimension) trunk ports 125, respectively. Specifically, with reference to the notional torus mesh depicted at FIG. 12, FIGS. 24-26 show the additional cut through paths created when special MTP®/MPO-32 R-keys 145 are inserted into the A1-C3 trunk ports 125. Once again, the numbers below the boxes in FIGS. 24-26 represent the 24 node ports 115 on the faceplate 110 of shuffle 100, while the numbers within the boxes (in the middle) represent the node or client location within the notional torus structure. The smaller numbers within the boxes (to/from which the arrowed lines emerge) represent fiber numbers.

This enhanced connectivity is available because each MTP®/MPO-32 based connector 130 contains connections to both east and west directions, which is why they cannot be used to directly connect lower level shuffles 100, and must instead connect to upper level shuffles 200, 300 to achieve greater than 24 node connectivity (as will be discussed below). The use of R-keys 145 in trunk ports 125 while shuffle 100 is connected to upper level shuffles 100, 200 also results in a network configuration that reduces the bisectional bandwidth between clusters.

The rules for creating enhanced connections within a LS24T torus configuration are supplied below and are configured to maximize the benefits of the enhanced connectivity when one or more of the trunk port sets A1-A3, B1-B3 and C1-C3 are used for enhanced connectivity. More specifically, the internal fiber cable connections within the internal fiber shuffle sub-assembly 170 for the Kx*Ky*Kz dimensions can be derived as follows:
using the Mod operator, which is the remainder of a number/divisor, (e.g. number MOD Divisor, returns the remainder of number/divisor, e.g. 13/5=2 with a remainder of 3, 13 Mod5=3)
Node #: current torus-based node number,
NextNode: next node to connect to
Kx, Ky, Kz: dimension of Torus

### Dimension 1

### NextNode=IF((MOD(Node #,Kx)),Node #+1,Node #-(Kx-1)))

### Dimension 2

### NextNode=IF (OR(Not(MOD(Node #, (Kx*Ky))), (Mod(Node #,(Kx*Ky))>=(Kx*Ky-(Kx-1)))), Node #-(Kx*(Ky-1)), Node #+Kx)

### Dimension 3

### NextNode=IF(OR(NOT(MOD(Node #,(Kx*Ky*Kz))),

### (MOD(Node #,(Kx*Ky*Kz))>=(Kx*Ky*Kz-((Kx*Ky)-1)))), Node #-(Kx*Ky*(Kz-1)), Node #+(Kx*Ky))

Dimension 4 (All rings in the enhanced connections are k=4.)
NextNode=Skip 6, add 1 if the node is already used

For 4:3:2
1-7-13-19-1
2-8-14-20-2
3-9-15-21-3
4-10-16-22-4
6-12-18-24-6
   Dimension 5 (All rings in the enhanced connections are k=4.)
   NextNode=Skip 1, Mod 12 move to other plane (i.e. always change planes)

For 4:3:2
1-14-3-16-1
9-22-11-24-9
2-15-4-17-2
6-19-8-21-6
   Dimension 6 (All rings in the enhanced connections are k=4.)
   NextNode=Skip 5, add 1 if the node is already used

For 4:3:2
1-6-11-16-1
21-2-7-12-21
17-22-3-8-17
13-18-23-4-13
9-14-19-24-9

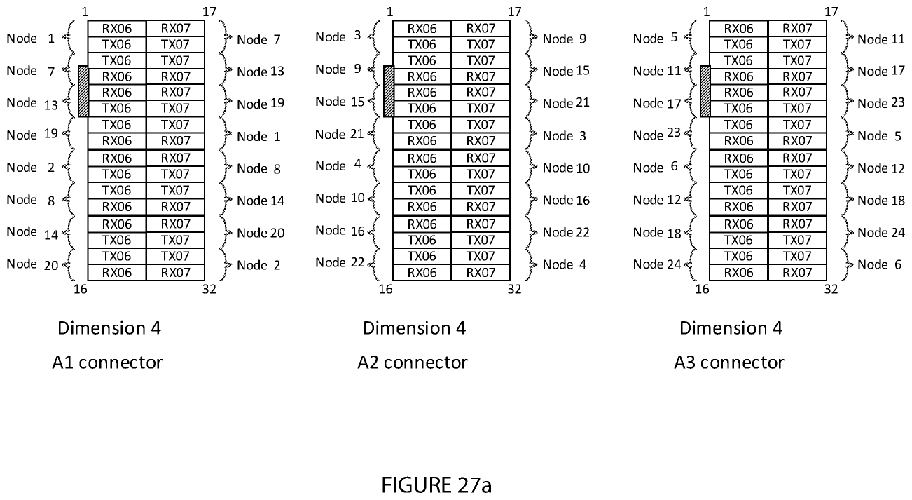

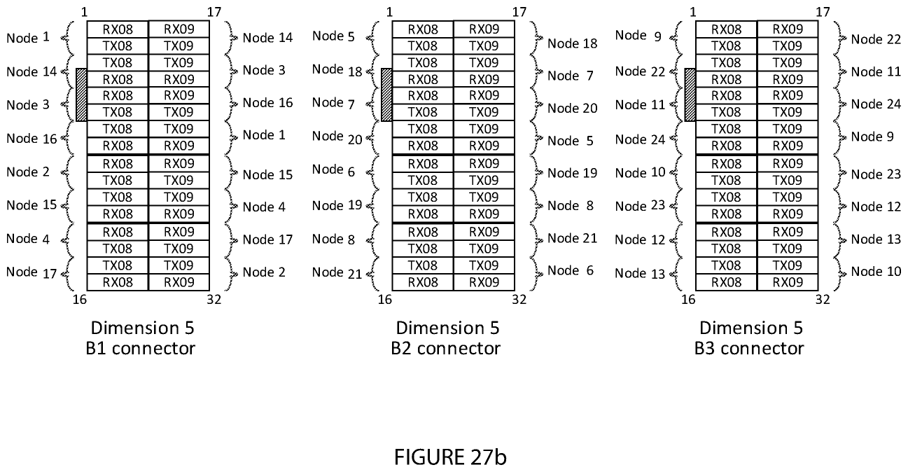

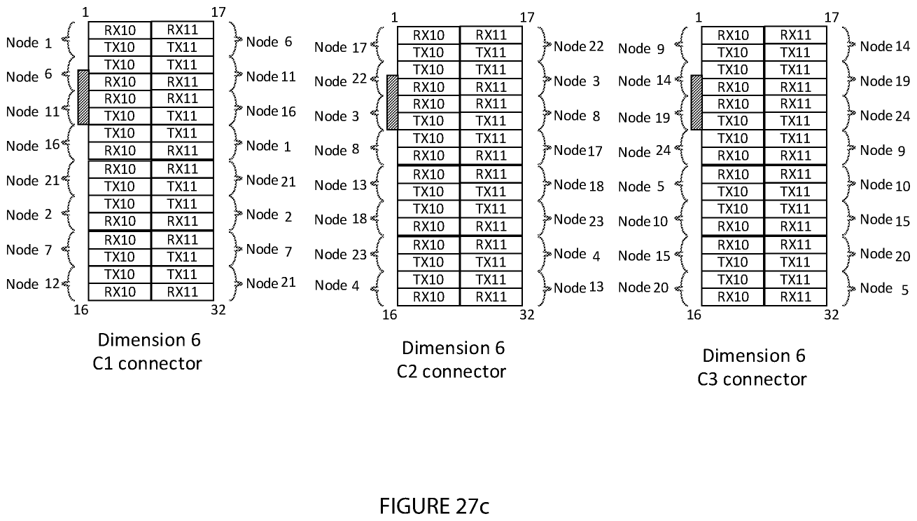

Given the foregoing, the pinout for the MTP®/MPO-32 based connectors 130 of trunk ports 125 on lower level shuffle 100 (i.e. A1-3 for dimension 4 connections, B1-3 for dimension connections, and C1-3 for dimension 6 connections) is provided at FIGS. 27a-c.

As for wiring connections to the shuffle 100, it is important to note that having optical connectors 120, 130 mounted to faceplate 110 is useful such that when a MTP®/MPO-24 or MTP®/MPO-32 cable is inserted into connector 120 or 130 respectively, the key on the inserted cable will be opposed to the key on the cable mounted internally to connectors 120, 130 on the inside of the shuffle. In this respect, the key on a cable from a node 50 connected externally to connector 120 will be opposed to the key on node port shuffle cable 180 connected internally to connector 120 within the shuffle. The key on a cable from an upper level shuffle 200, 300 connected externally to connector 130 will be opposed to the key on trunk port shuffle cable 185 connected internally to connector 130 within the shuffle. This provides a type A reversal of the fiber channels rather than having to twist internal fibers. The skilled person would also understand that in order to terminate the transmit fibers from a node or client 50 with the receive fibers from another node or client 50 for transmission purposes, the pinout for connector 120 will have to match the pinout for the connector on node or client 50. The internal wiring for shuffle 100 should also preferably mimic the ANSI TypeA:2-2 cable connectivity. Similar considerations apply to upper level shuffles 200, 300.

As previously noted, upper level shuffles 200, 300 provide for expansion of the number of lower level shuffles 100 (and therefore nodes or clients 50) that can be interconnected, and can expand and close off the 4^{th}, 5^{th}, and 6^{th} dimensions of the network. The use of upper level shuffles 200, 300 can be mixed and matched in order to provide different dimension sizes (e.g. (4×3×2)×2×3×2 or (4×3×2)×3×3×2).

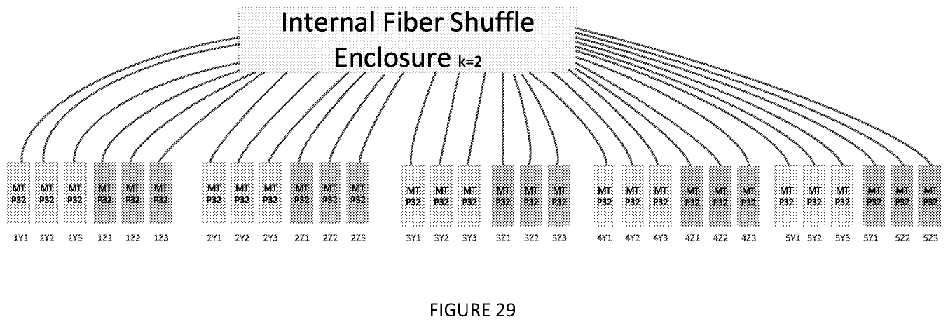

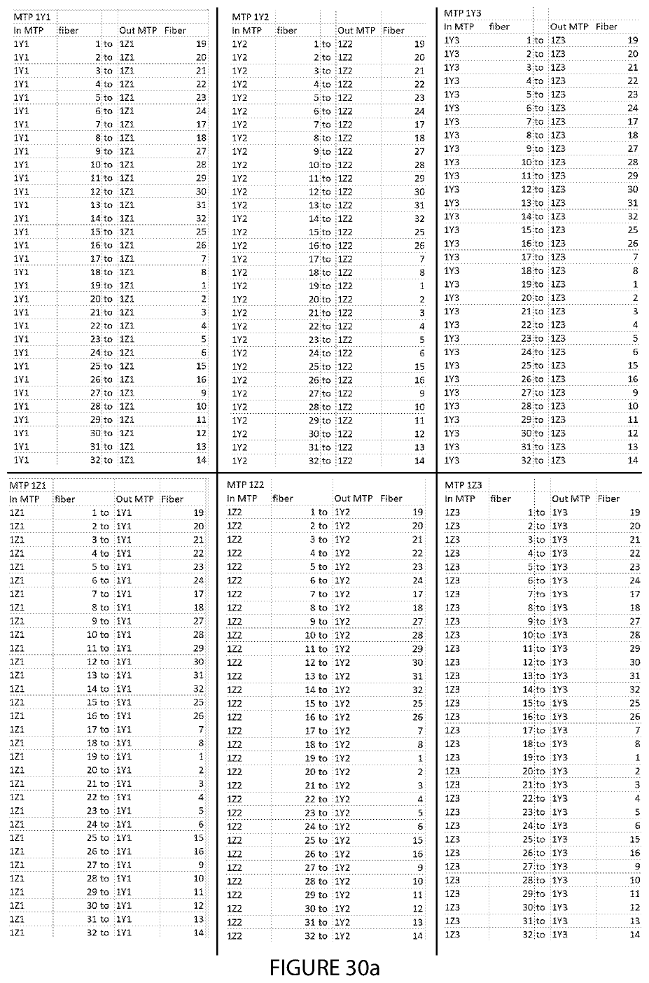

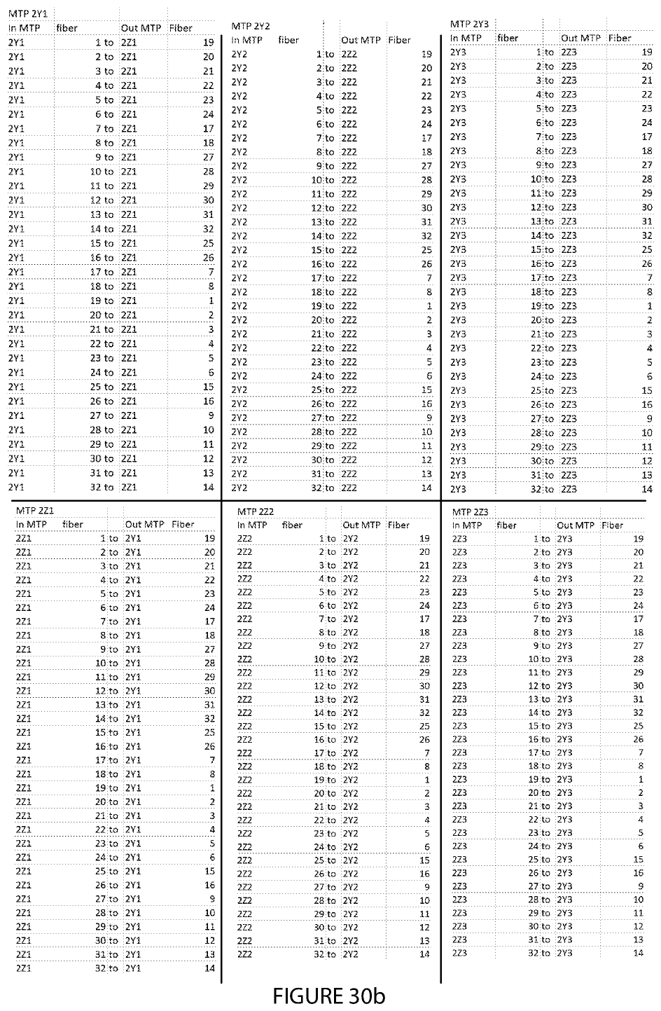

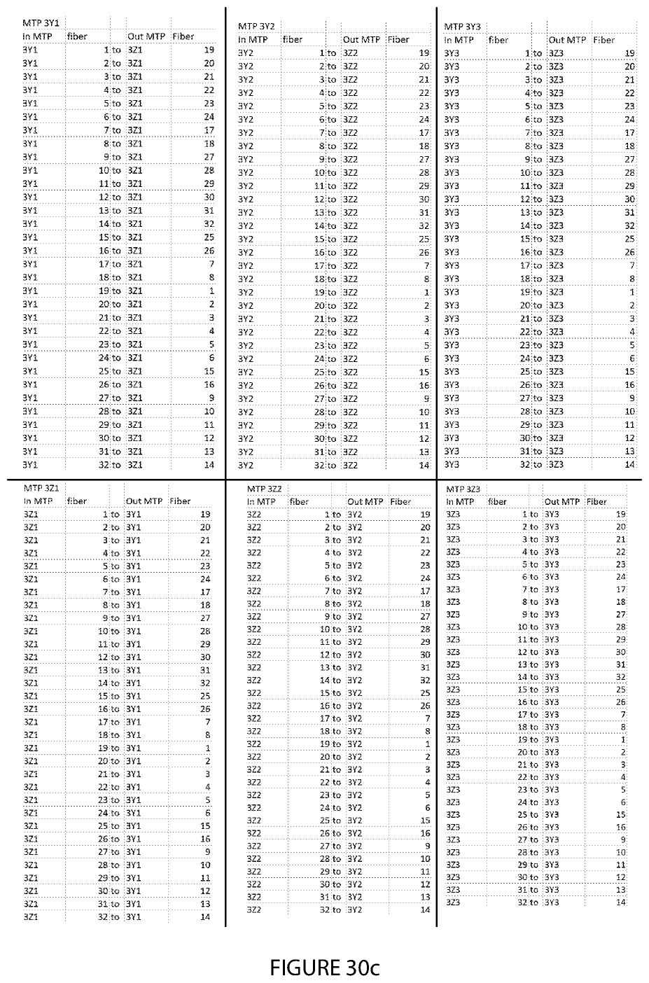

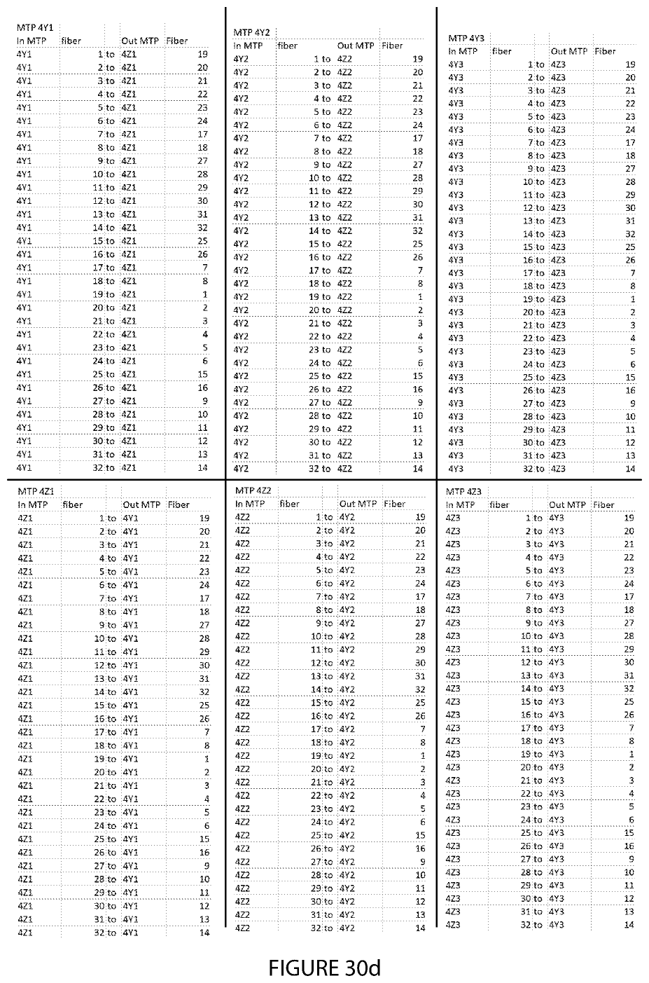

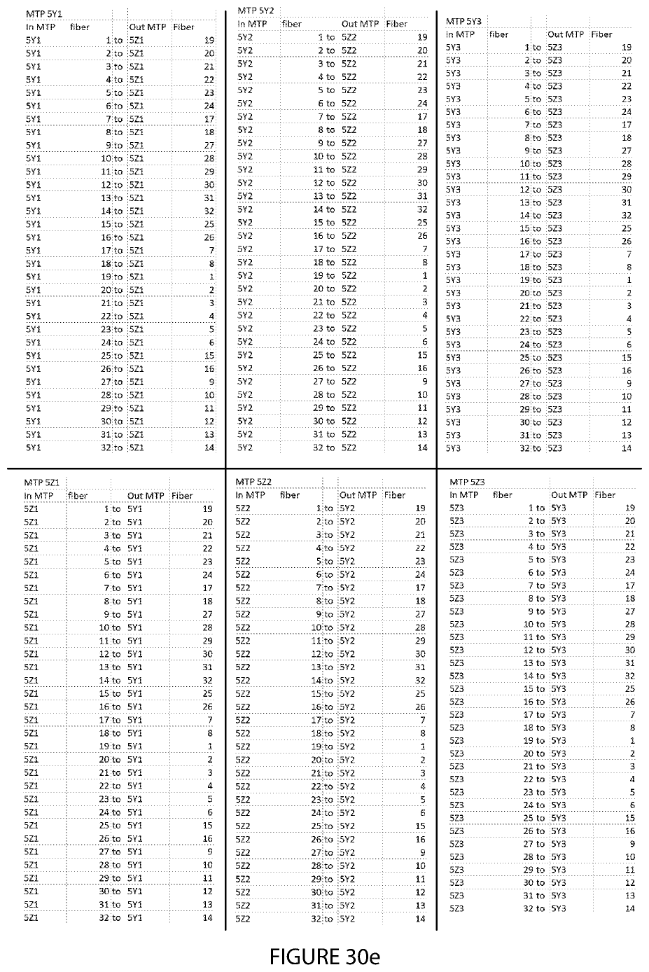

Upper level shuffle 200 (US2T), as shown in FIGS. 28a-c with dust covers on connectors 130, is monolithic, only interconnects with the lower level shuffles 100 (LS24T) in a preferred embodiment (and not with other upper level shuffles), and provides an additional torus dimension with 2 nodes in each ring (k=2), supporting a 4×3×2×2×2×2 (192 network card) configuration. As previously noted, upper level shuffle 200 is constructed in a manner similar to that of lower level shuffle 100, and it is thus unnecessary to discuss same in great detail. Upper level shuffle 200 has MTP®/MPO-32 (male) low loss connectors 130 (to enable connection with the trunk ports 125 of lower level shuffle 100 and to enable a higher density interconnect) in keyup/keydown bulkhead adapters 165 that preferably connect to lower level shuffles 100 through OM4, polarity A cables, with low loss female ends. MTP®/MPO-32 fiber R-keys 145 are preferably not used or necessary with upper level shuffle 200, as they may cause too much optical loss. However, a skilled person would understand that MTP®/MPO-32 fiber R-keys 145 may be used with upper level shuffle 200 (or other upper level shuffles) to, for instance, reduce the need for upper level shuffle swap outs and cable moves when expanding the network, to simplify physical deployment when the network growth plan involves intermediate clusters before final configuration, or to eliminate the need for deploying fully unpopulated lower level shuffles 100 (LS24T) filled with MTP®/MPO-24 fiber R-keys 140. It should be apparent that the shorthand term “US2T” is a reference to “upper shuffle” that can provide an additional torus dimension with 2 nodes in each ring (k=2). FIG. 29 displays a general overview of the internal fiber shuffle enclosure for upper level shuffle 200. The fiber connectivity tables for the upper level shuffle 200 (US2T) are provided at FIGS. 30a-e.

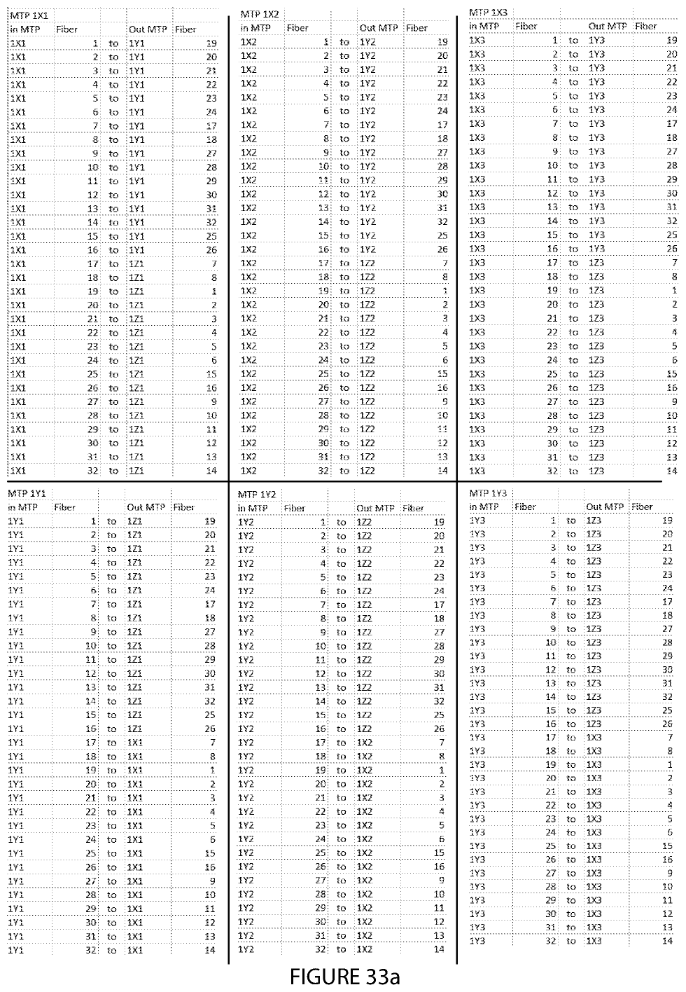

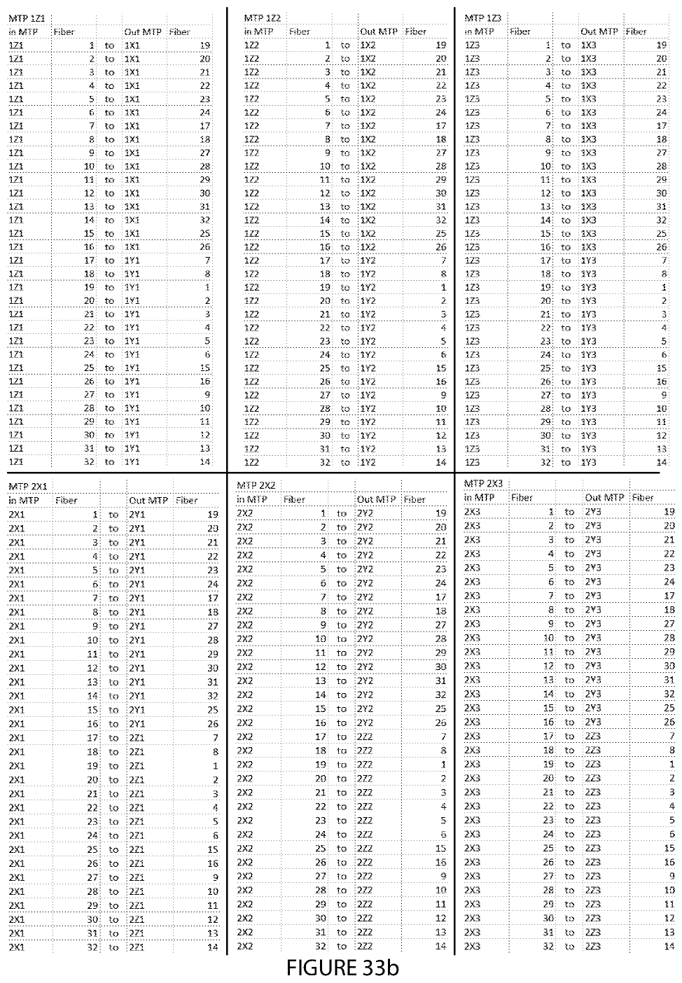

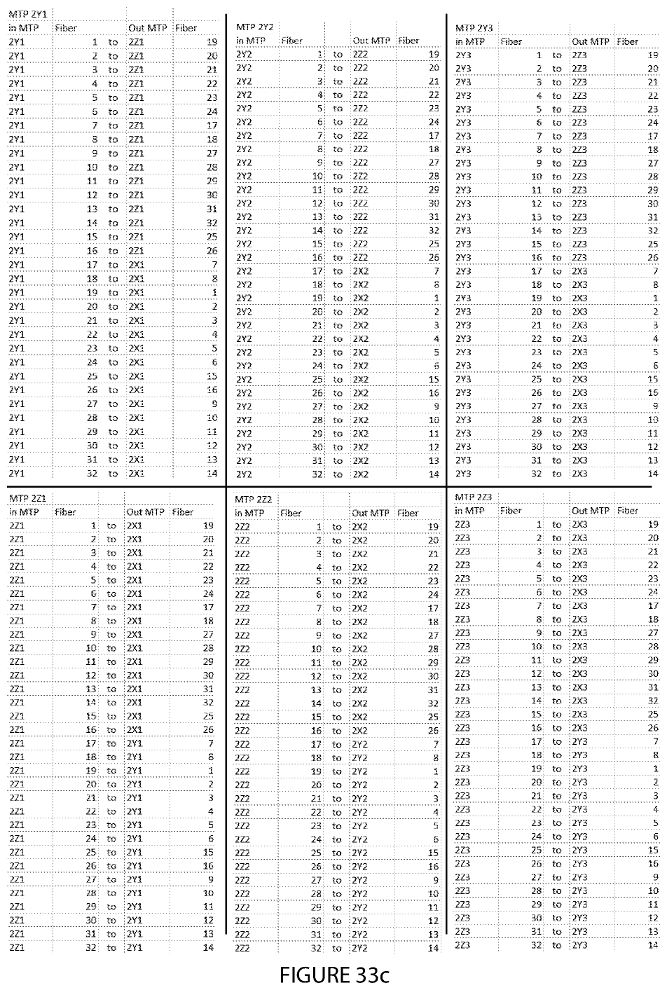

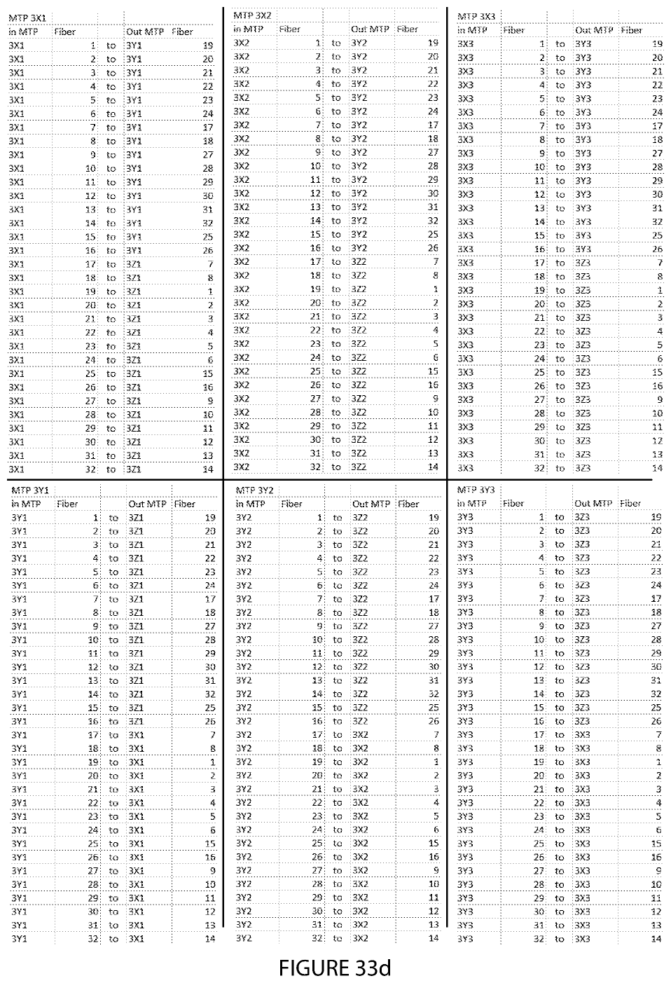

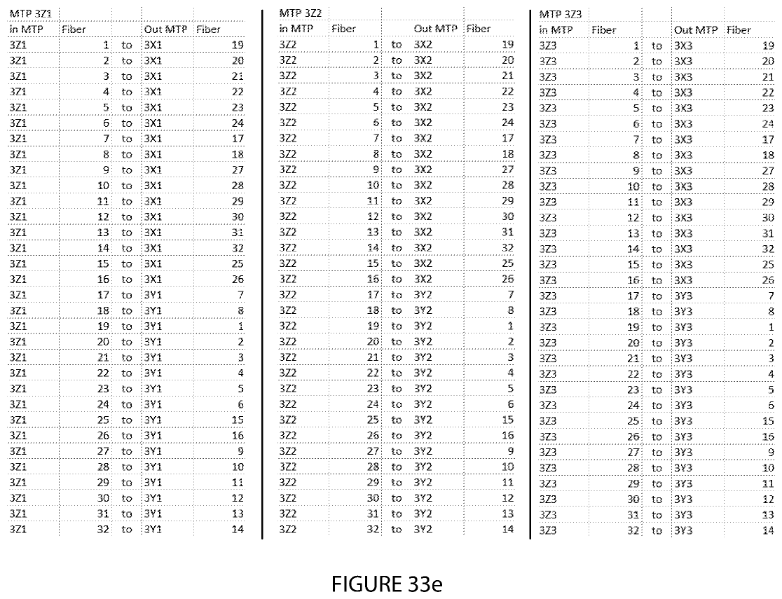

Another variant of the upper level shuffle, 300 (US3T), as shown in FIGS. 31a-c with dust covers on connectors 130, is also monolithic, only interconnects with the lower level shuffles 100 (LS24T) in a preferred embodiment (and not with other upper level shuffles), and provides an additional torus dimension with 3 nodes in each ring (k=3) supporting a 4×3×2×3×3×3 (648 network card) configuration. As previously noted, upper level shuffle 300 is constructed in a manner similar to that of lower level shuffle 100, and it is thus unnecessary to discuss same in great detail. Upper level shuffle 300 has 27 MPT/MP032 (male) low loss connectors 130 (to enable connection to the trunk ports 125 of lower level shuffle 100 and to enable a higher density interconnect) in keyup/keydown bulkhead adapters 165 that preferably connect to lower level shuffles 100 through OM4, polarity A cables, with low loss female ends. MTP®/MPO-32 fiber R-keys 145 are preferably not used or necessary with upper level shuffle 300, as they may cause too much optical loss. However, a skilled person would understand that MTP®/MPO-32 fiber R-keys 145 may be used with upper level shuffle 300 (or other upper level shuffles) to, for instance, reduce the need for upper level shuffle swap outs and cable moves when expanding the network, to simplify physical deployment when the network growth plan involves intermediate clusters before final configuration, or to eliminate the need for deploying fully unpopulated lower level shuffles 100 (LS24T) filled with MTP®/MPO-24 fiber R-keys 140. It should be apparent that the shorthand term “US3T” is a reference to “upper shuffle” that can provide an additional torus dimension with 3 nodes in each ring (k=3). FIG. 32 displays a general overview of the internal fiber shuffle enclosure for upper level shuffle 300. The fiber connectivity tables for the upper level shuffle 300 (US3T) are provided at FIGS. 33a-e.

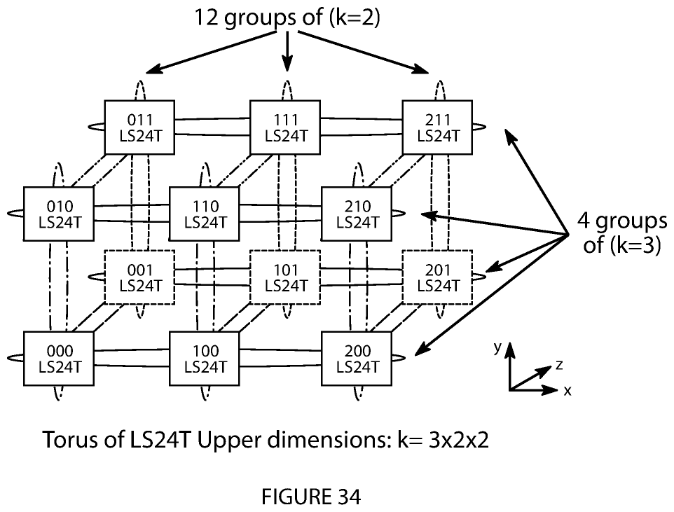

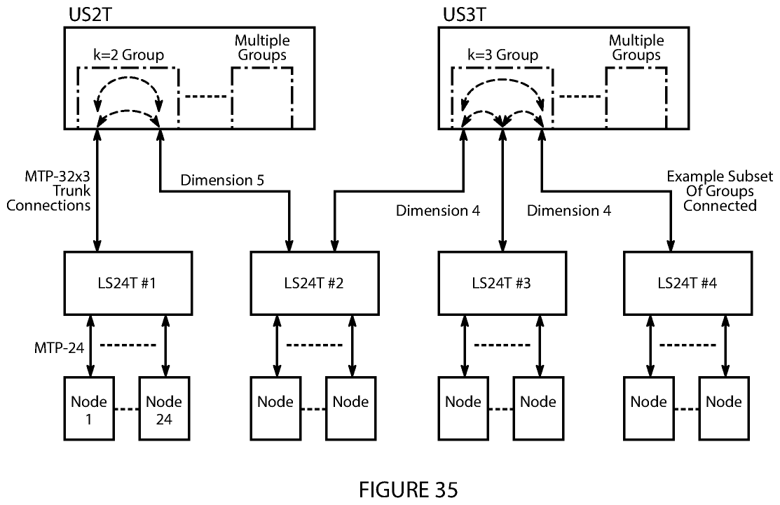

Each of the upper level shuffles 200, 300 provides a number of independent groups of connections for creating k=n torus single dimension loops, where n is 2, 3, or more. In the non-limiting examples shown in FIGS. 28a-c and 31a-c, an upper level shuffle 200 (US2T) contains groups and an upper level shuffle 300 (US3T) provides 3 groups, respectively. FIG. 34 illustrates how a set of 12 lower level shuffles 100 (LS24T) may be connected in a (4×3×2)×3×2×2 torus configuration for a total of 288 nodes. This illustration shows the torus comprises 12 edge loops (groups) of k=2 and 4 groups of k=3. Each of these groups is formed by connecting trunk ports 125 of a lower level shuffle 100 (LS24T) for a single dimension to an upper shuffle group. FIG. 35 illustrates that an upper level shuffle 200 group (US2T) may be used to form a k=2 loop between lower level shuffles 100 (e.g. LS24T #1 and #2) using one set of upper dimension trunk connections, while an upper level shuffle 300 group (US3T) is used to form a k=3 loop between lower level shuffles 100 (e.g. LS24T #2, #3 and #4) using another set of trunk connections for a different dimension.

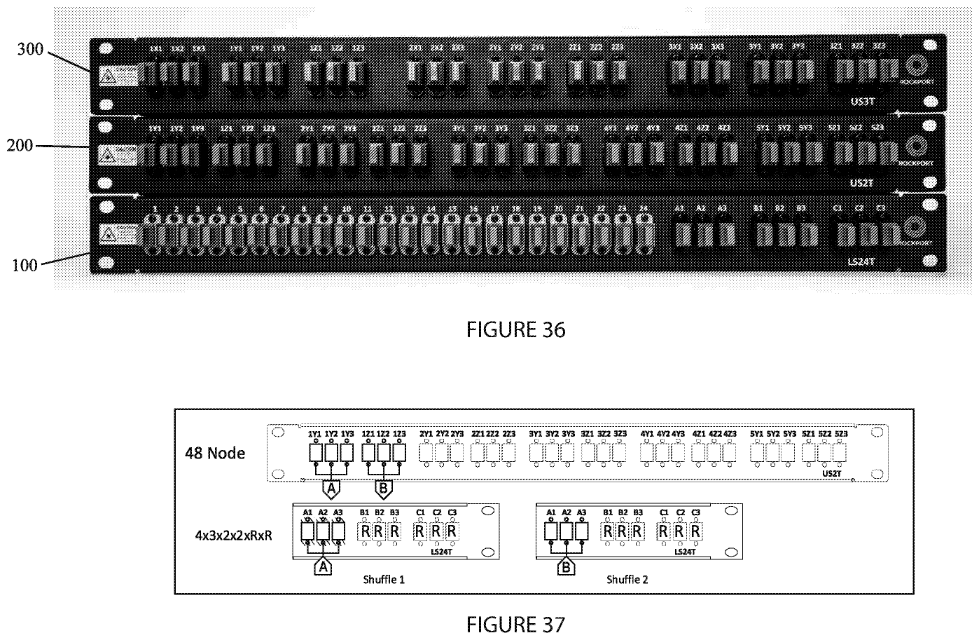

FIG. 36 displays a photograph showing how in one embodiment a configuration comprising shuffles 100, 200, and 300 may be located within a rack. FIGS. 37 to 45 display various diagrams representing examples of connection scenarios whereby lower level shuffles 100 are connected to upper level shuffles 200, 300 to implement various network topologies. In each example configuration, the lower level shuffles 100 (here LS24T) are assumed to have all 24 node ports 115 connected to nodes or clients 50, and therefore only the A1-A3, B1-B3, and C1-C3 trunk ports 125 on the shuffles 100 are usually shown for simplicity purposes.

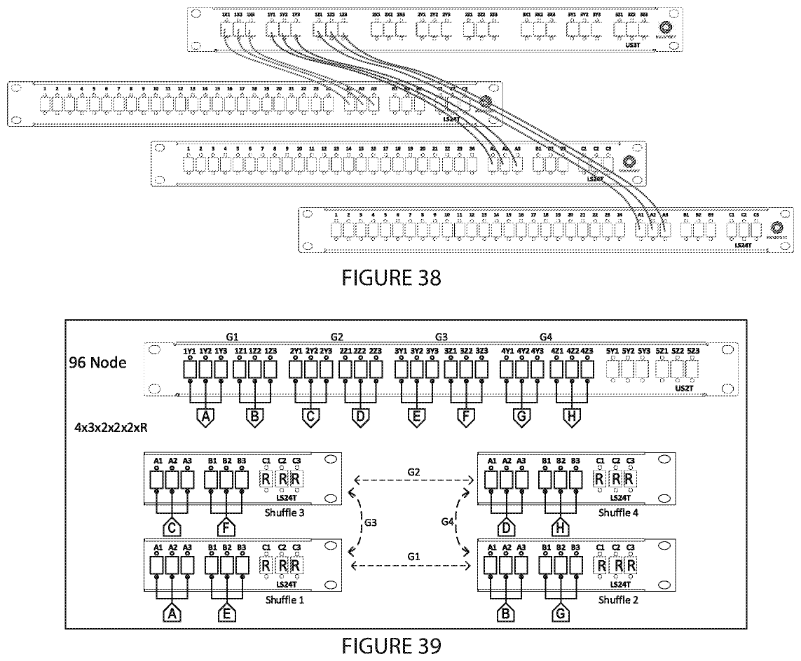

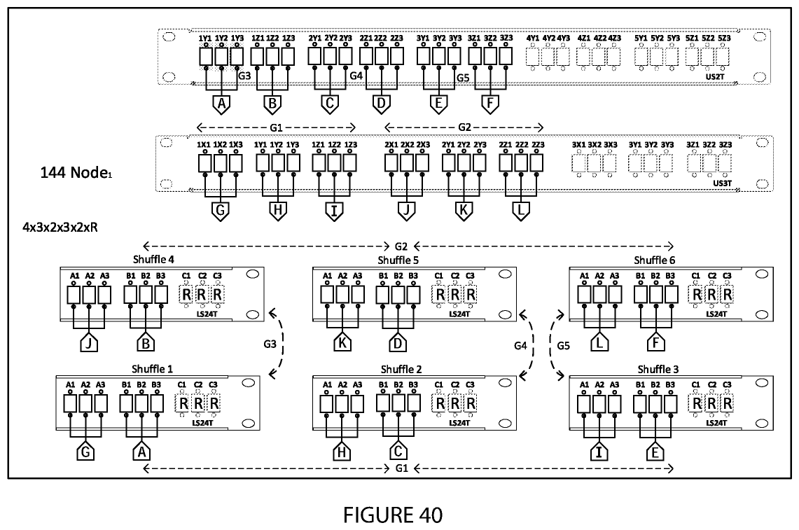

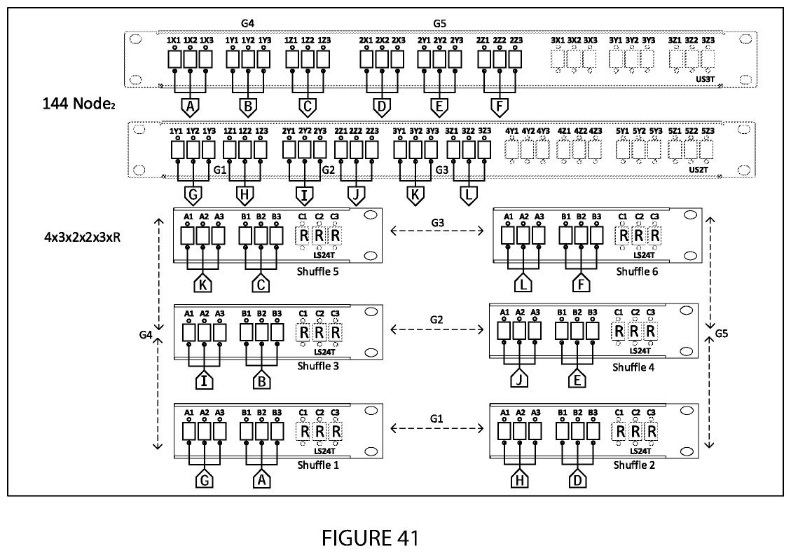

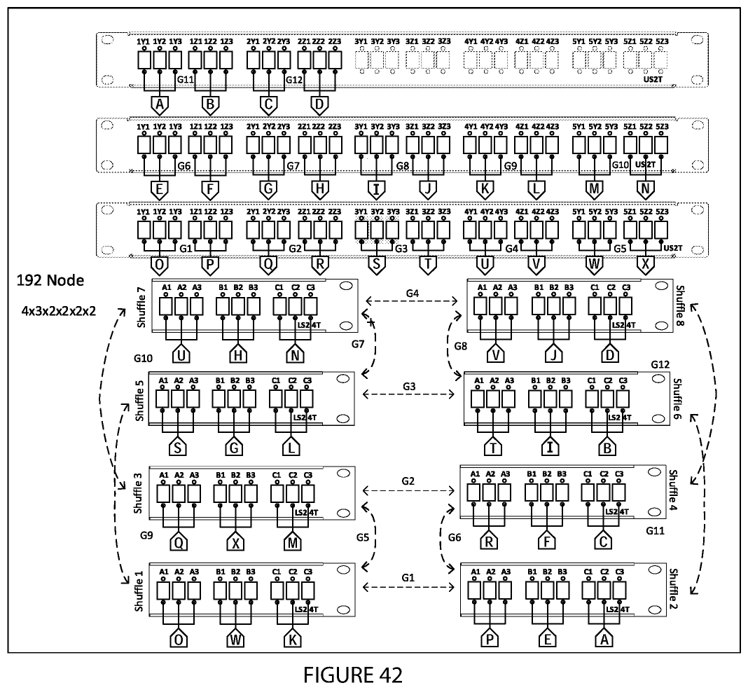

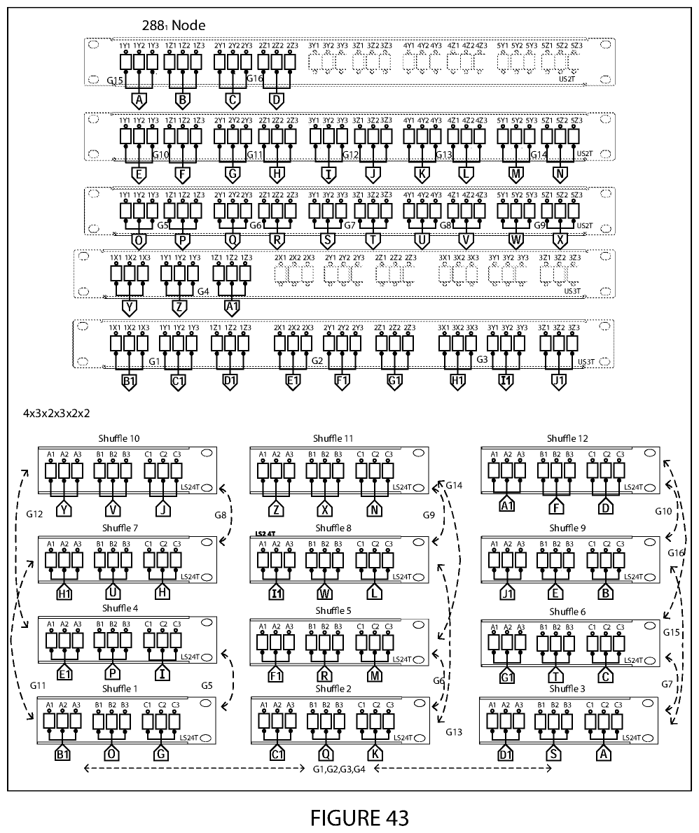

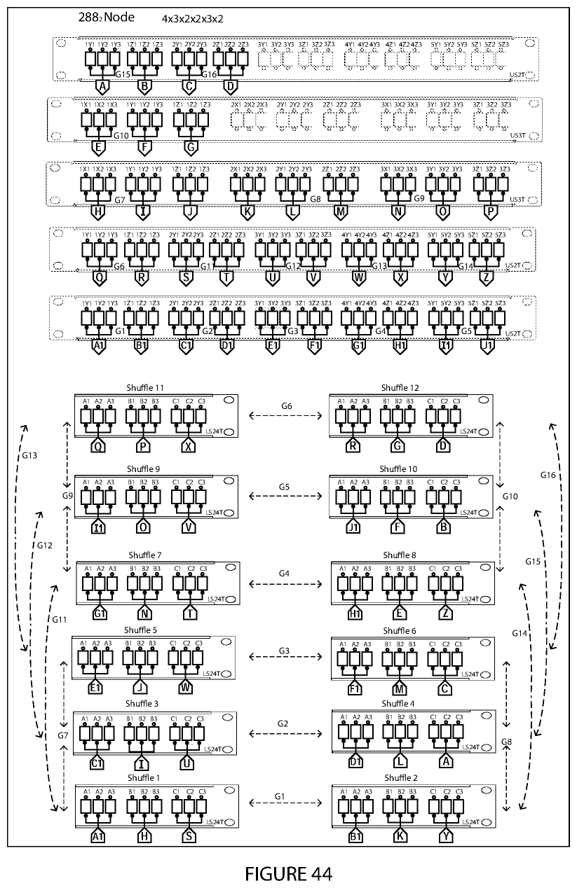

FIG. 37 depicts a 48 node network (4 dimensions) comprising two lower level shuffles 100 (LS24T), each connected as shown to an upper level shuffle 200 (US2T). Specifically, the MTP®/MPO-32 (male) low loss connectors 130 at trunk ports A1/A2/A3 125 of “Shuffle 1” is cabled/connected to the MTP®/MPO-32 (male) low loss connectors 130 at ports 1Y1/1Y2/1Y3 of US2T 200 (as denoted by the pentagon-shaped tab marked as “A” on “Shuffle 1” and the corresponding pentagon-shaped tab marked as “A” on US2T 200). Similarly, the MTP®/MPO-32 (male) low loss connectors 130 at trunk ports A1/A2/A3 125 of “Shuffle 2” is cabled/connected to the MTP®/MPO-32 (male) low loss connectors 130 at ports 1Z1/1Z2/1Z3 of US2T 200 (as denoted by the pentagon-shaped tab marked as “B” on “Shuffle 2” and the corresponding pentagon-shaped tab marked as “B” on US2T 200). Pentagon-shaped tabs with alphanumeric characters are similarly used in FIGS. 39-45 to show potential cabling/connections between the trunk ports 125 of lower level shuffles 100 and upper level shuffles 200, 300. Those trunk ports 125 with an “R” represent trunk ports 125 connected to R-Keys 145 to close connections and provide “enhanced connectivity”. FIG. 38 depicts a 72 node network (4 dimensions) comprising three lower level shuffles 100 (LS24T), each connected, as shown in this example with lines representing optical cables (e.g. OM4, polarity A cables, with low loss female ends), to an upper level shuffle 300 (US3T). FIG. 39 depicts a 96 node network (5 dimensions) comprising four lower level shuffles 100 (LS24T), each connected as shown to an upper level shuffle 200 (US2T). FIG. 40 depicts a 144 node network (5 dimensions) comprising six lower level shuffles 100 (LS24T), each connected as shown to an upper level shuffle 200 (US2T) and an upper level shuffle 300 (US3T). FIG. 41 depicts another way of implementing a 144 node network (5 dimensions) comprising six lower level shuffles 100 (LS24T), each connected as shown to an upper level shuffle 200 (US2T) and an upper level shuffle 300 (US3T). FIG. 42 depicts a 192 node network (6 dimensions) comprising eight lower level shuffles 100 (LS24T) connected as shown to three upper level shuffles 200 (US2T). FIG. 43 depicts a 288 node network (6 dimensions) comprising twelve lower level shuffles 100 (LS24T) connected as shown to three upper level shuffles 200 (US2T) and two upper level shuffles 300 (US3T). FIG. 44 depicts another way of implementing a 288 node network (6 dimensions) comprising twelve lower level shuffles 100 (LS24T) connected as shown to three upper level shuffles 200 (US2T) and two upper level shuffles 300 (US3T).

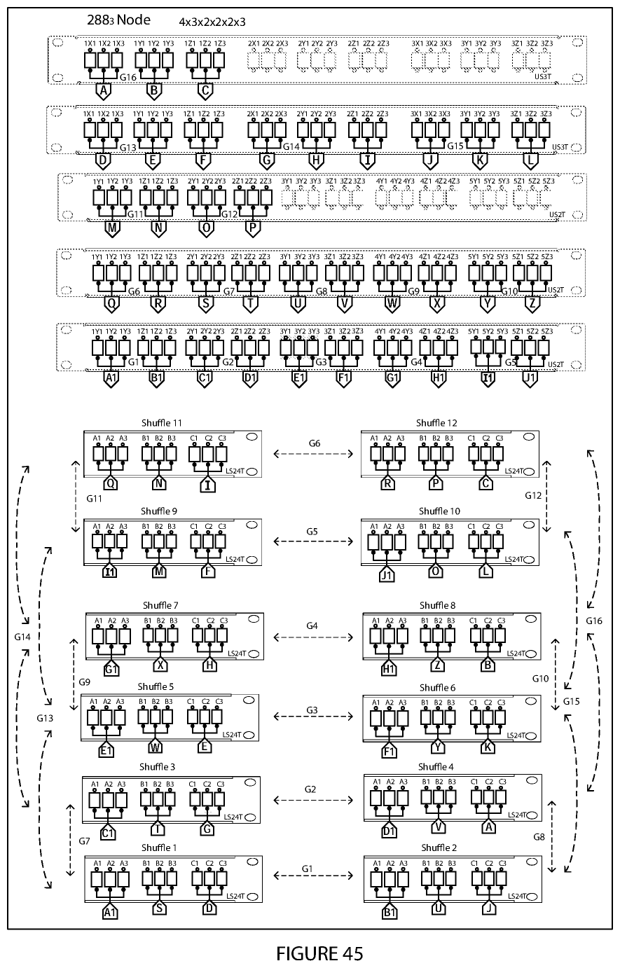

FIG. 45 depicts yet another way of implementing a 288 node network (6 dimensions) comprising twelve lower level shuffles 100 (LS24T) connected as shown to three upper level shuffles 200 (US2T) and two upper level shuffles 300 (US3T).

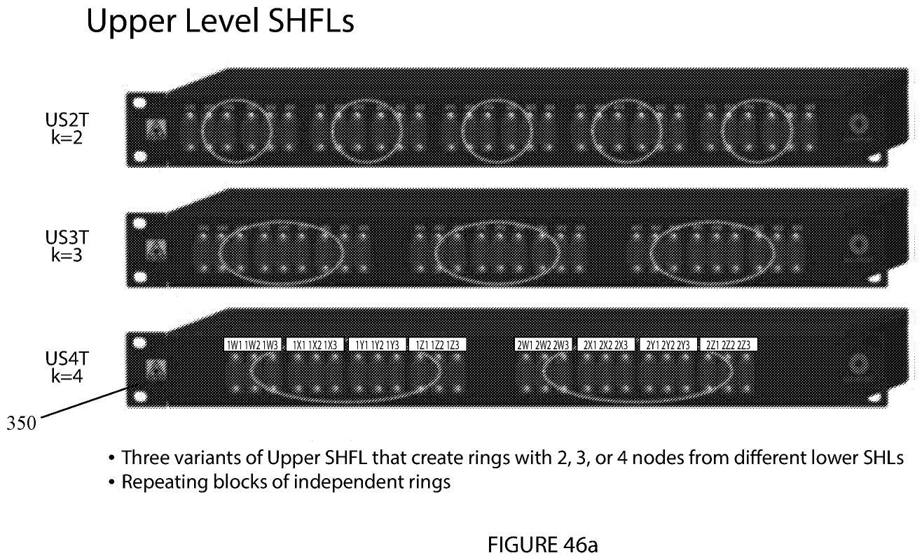

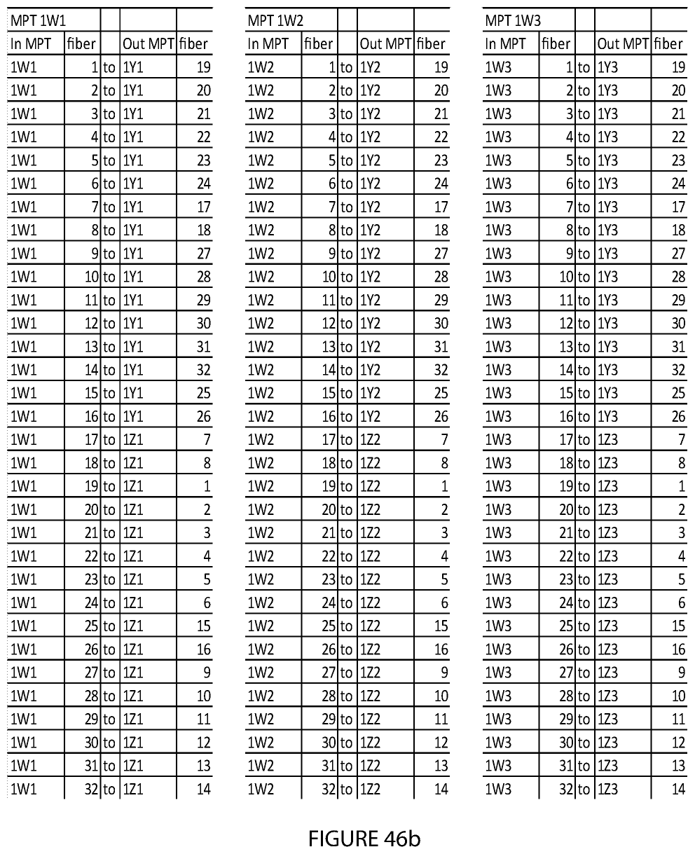

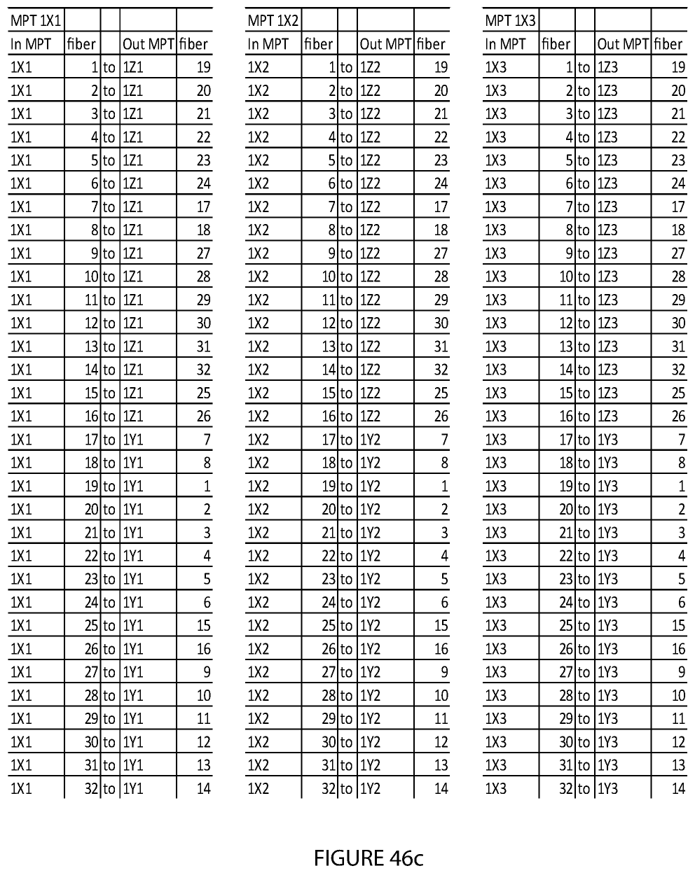

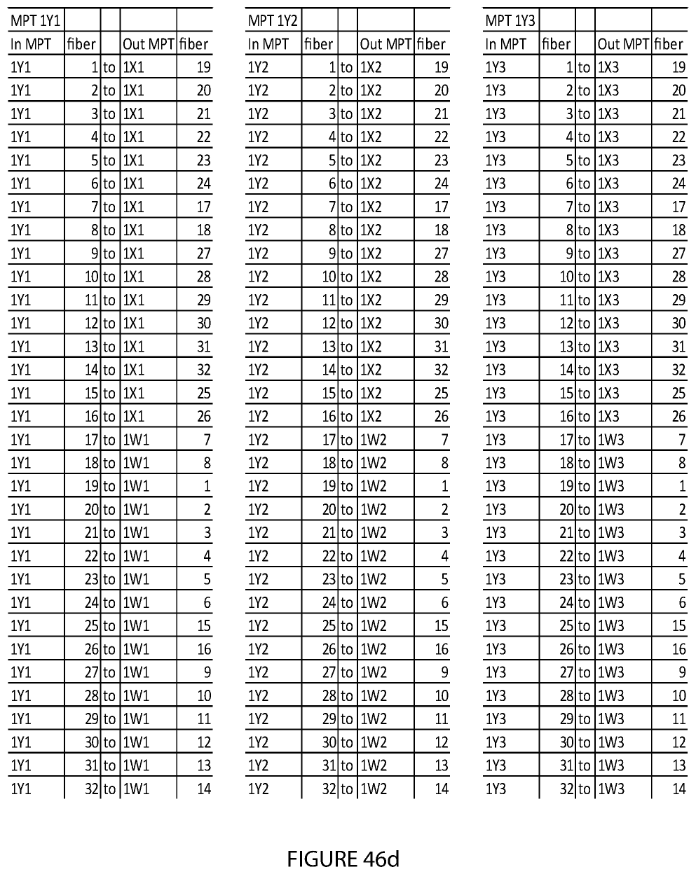

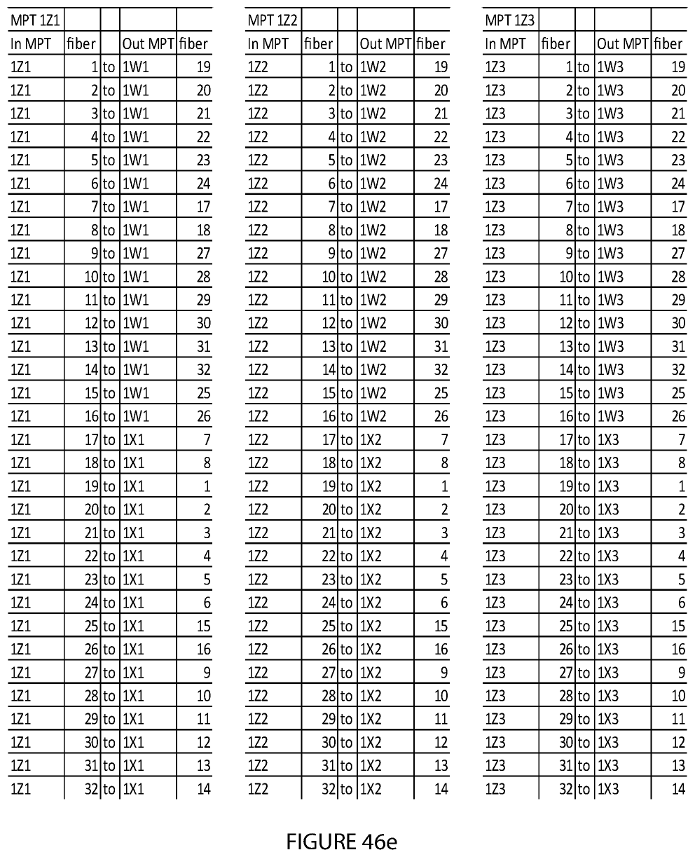

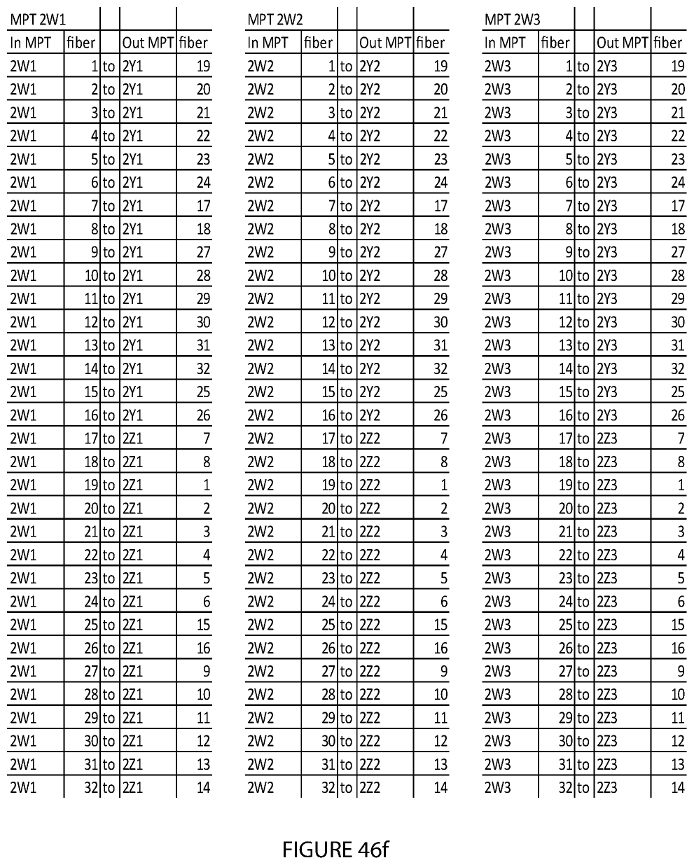

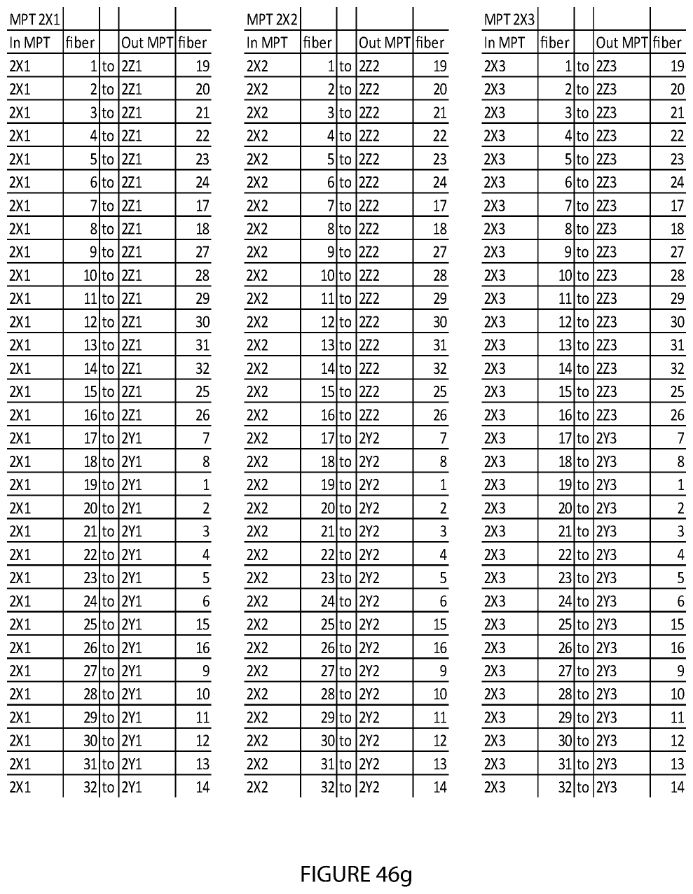

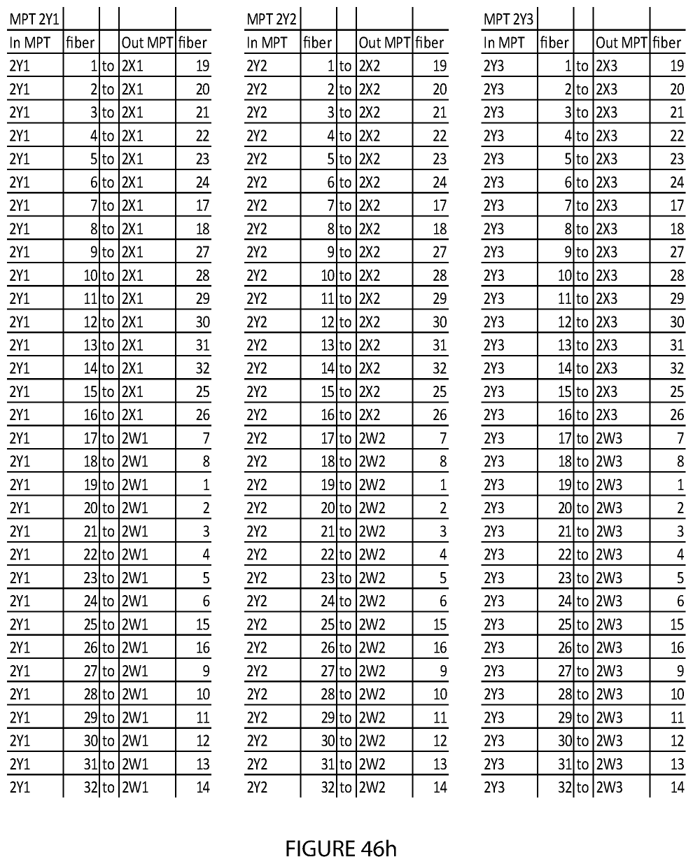

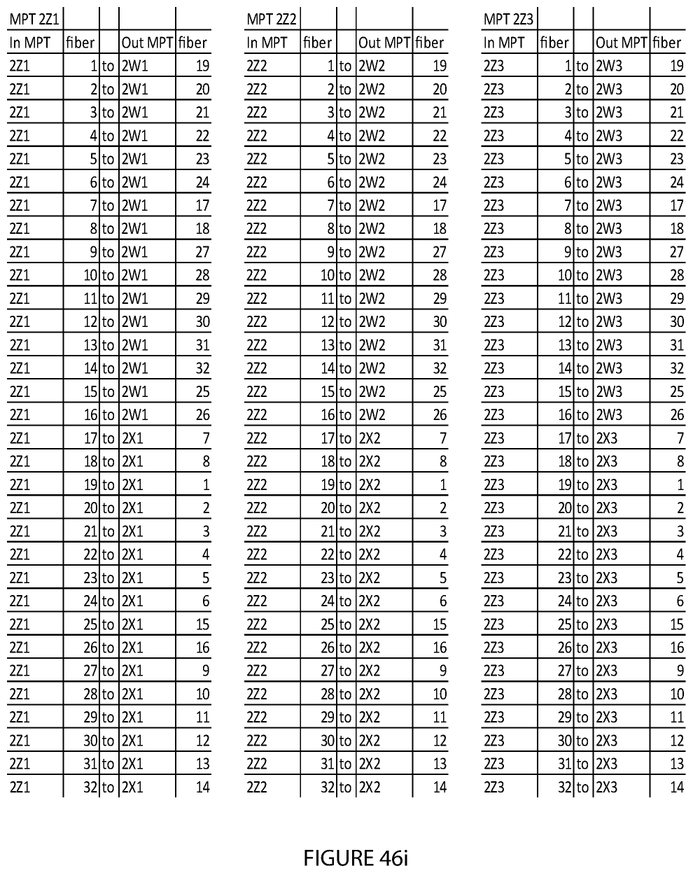

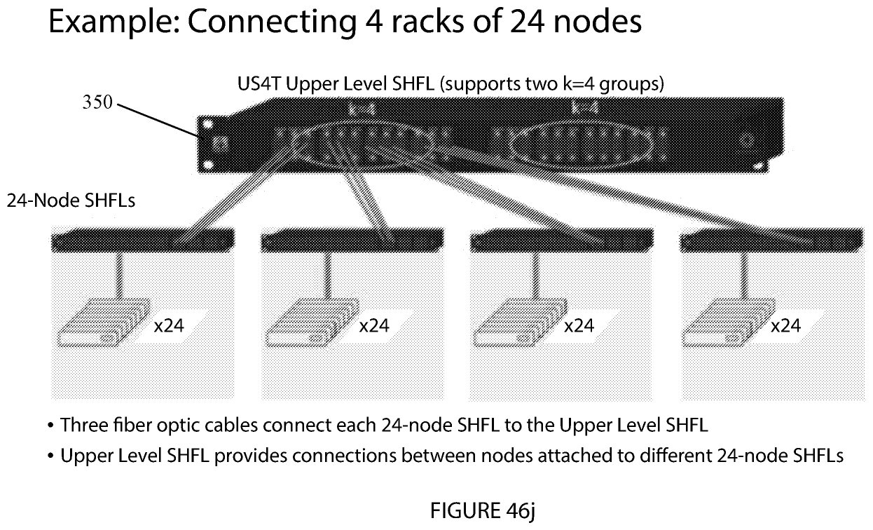

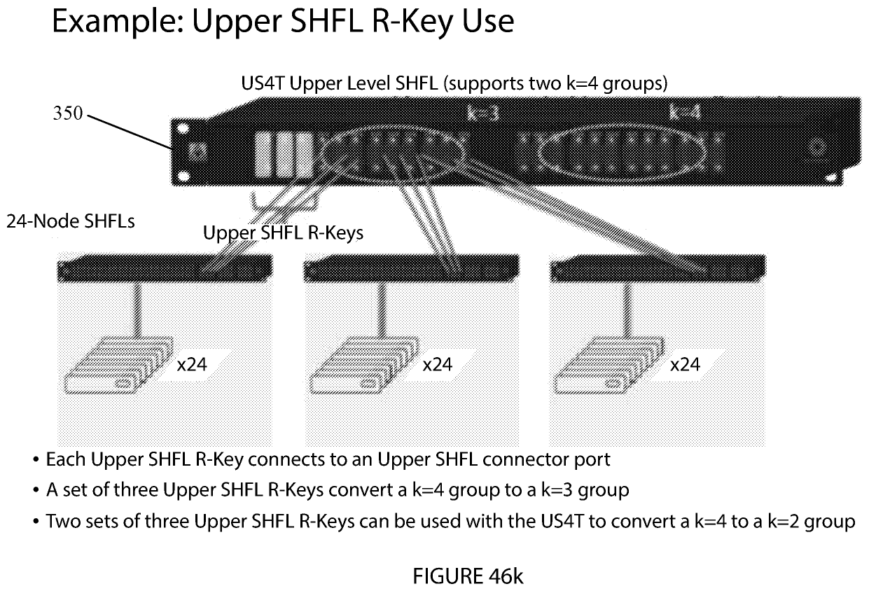

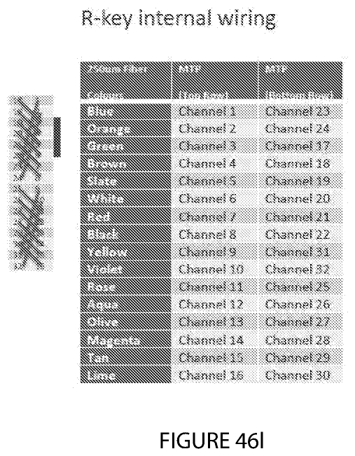

It would be obvious to one skilled in the art based on the teachings herein that other variants of the upper level shuffle can be configured in a similar manner to provide dimensions with 4 or more nodes in each ring. For instance, based on the teachings herein, a skilled person would be able to implement an upper level shuffle 350 with k=4 (e.g. US4T), as shown in FIG. 46a. Example internal wiring connections for US4T are provided at FIGS. 46b-i. Connecting to lower level shuffles 100 would be well understood based on the teachings herein, as shown in FIG. 46j. In addition, a skilled person would understand based on the teachings herein that revised R-keys could potentially be used in upper level shuffles (e.g. US4T) to convert a k=4 group, for instance, to a k=3 or k=2 group for network implementations, as shown in FIG. 46k. Example internal wiring for such a revised upper shuffle R-key is shown at FIG. 46l. Of note, the internal wiring of the upper level shuffles, e.g. US4T, is preferably such that when two upper shuffle R-keys are connected in series (i.e. next to each other) on the faceplate, the optical path does not result in two consecutive R-key connector paths in series within the e.g. k=4 ring itself (so as to minimize connector loss between any two members of the k=4 ring group).

It would be obvious to one skilled in the art based on the teachings herein that shuffles can be configured to create any high radix topology. In one embodiment, shuffles could be configured to create a dragonfly topology for instance. In this respect, a lower level shuffle could be configured to create the full mesh or flattened butterfly group topology of the dragonfly using links L1 through L8 while an upper level shuffle could be configured to create the global inter-group connectivity of the dragonfly using links L9 through L12.

In another embodiment, a skilled person may wish to implement a shuffle that provides for efficient and simple node or client 50 to device connectivity, as opposed to implementing a shuffle system used to directly interconnect nodes or clients that may carry network traffic. For instance, it may be advantageous in a data center environment to disaggregate servers by moving peripheral components (e.g. GPUs, SSDs, FPGAs, DRAM, etc.) from within a server chassis to external chassis located nearby. This could be done by employing a shuffle implementation that provides the necessary linkage between servers and peripheral components. Such shuffles would provide an elegant means for simplifying wiring connections.

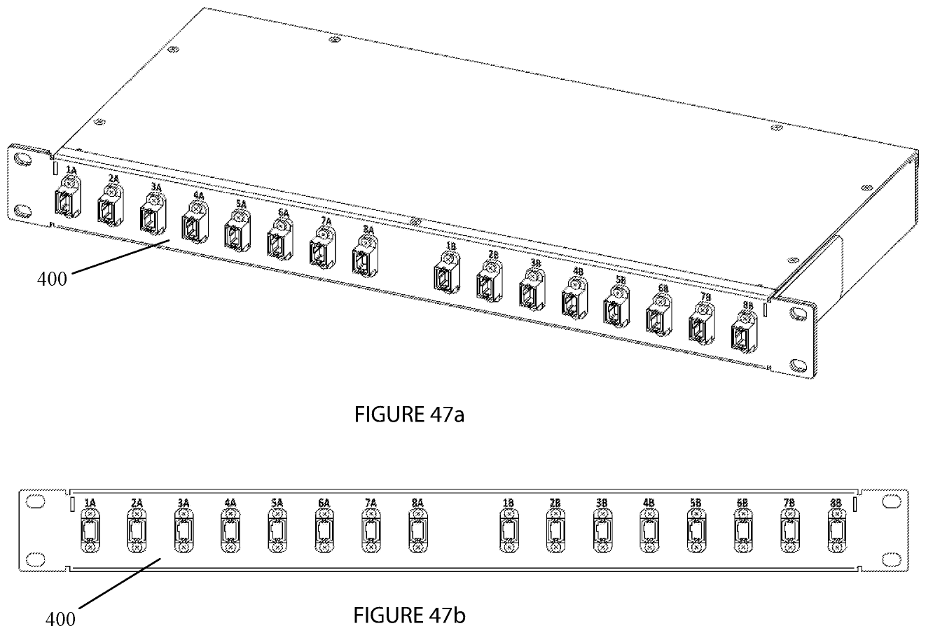

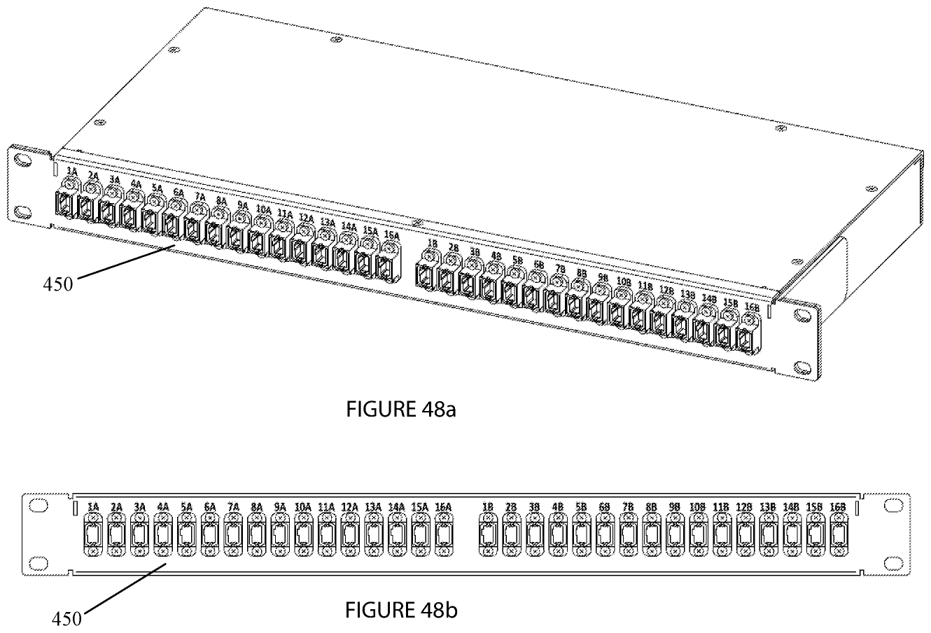

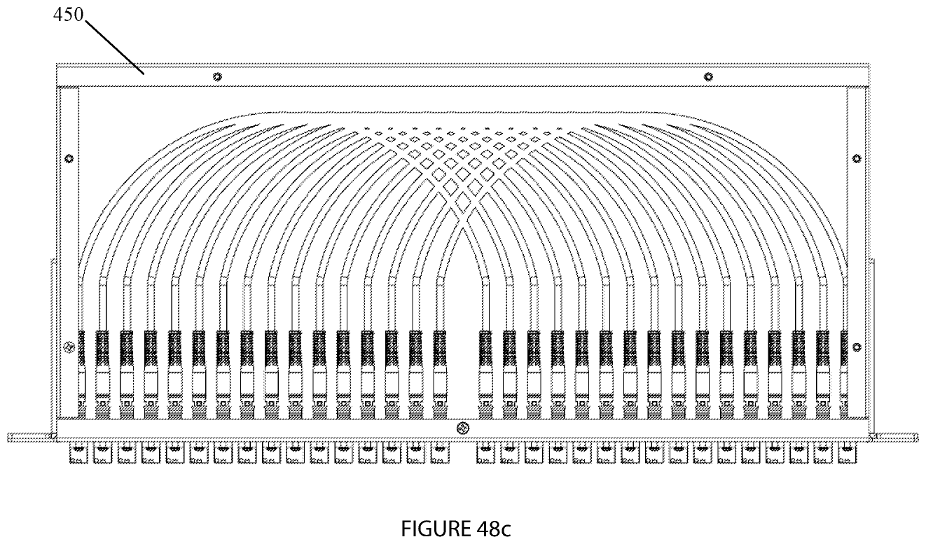

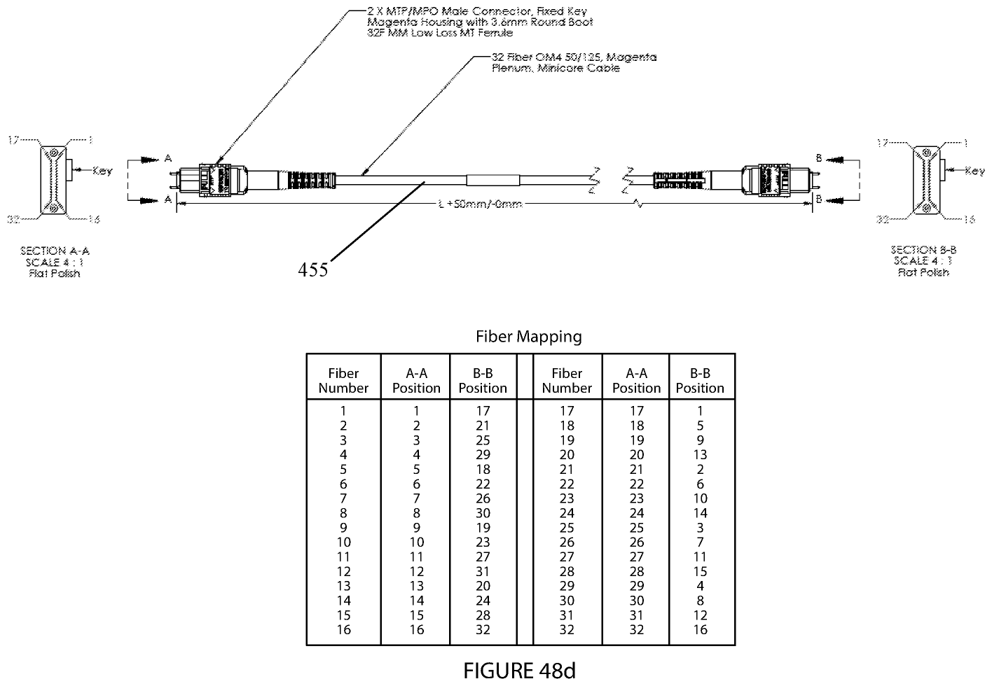

FIGS. 47a and b display perspective and front-side views respectively of an embodiment of a shuffle 400 that may be used, for instance, to connect nodes or clients 50 connected to the xA ports of shuffle 400 to devices or peripheral components connected to the xB ports of shuffle 400. Similarly, FIGS. 48a and b display perspective and front-side views respectively of another embodiment of a shuffle 450 that may be used, for instance, to connect nodes or clients 50 connected to the xA ports of shuffle 450 to devices or peripheral components connected to the xB ports of shuffle 450. FIG. 48c provides a top view representative drawing of shuffle 450 (cover removed) showing how the connections may be made in one embodiment. FIG. 48d provides an example internal shuffle cable 455 embodiment with fiber mapping that may be used to make the necessary connections between the xA and xB ports of shuffle 450.

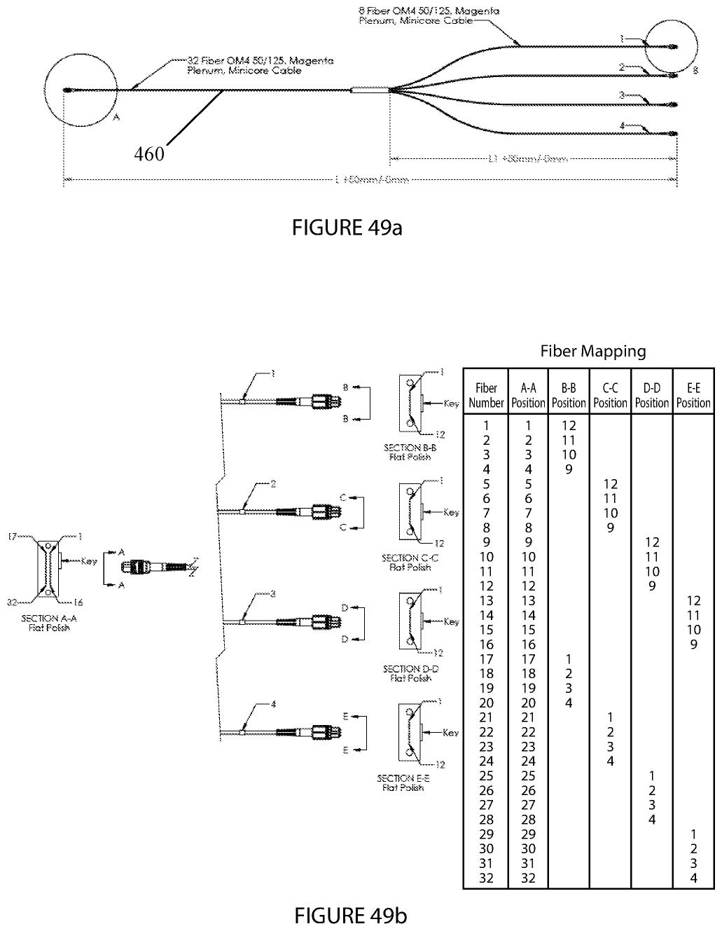

In yet another embodiment, the skilled person may wish to utilize a 4:1 optical cable 460 (as but one example of a multiple connection cable), as shown at FIG. 49a, to allow the connection of four nodes or clients 50 to a single xA port of shuffle 400, 450 for connection to devices or peripheral components connected to xB ports of shuffle 400, 450. FIG. 49b provides an example of the fiber mapping that could be used to provide such connectivity.

Although throughout this disclosure a number of specific or exemplary aspects and embodiments of shuffles in accordance with the present invention have been described, as previously stated, based on the teachings herein a person skilled in the art would be able to implement any number of different embodiments or configurations of shuffles that are capable of supporting a smaller or much larger number of interconnected nodes or clients in various topologies, whatever such nodes or clients may be, as desired. As such, the skilled person would understand how to create shuffles that implement topologies other than a torus mesh, such as dragonfly, slim fly, and other higher radix topologies. Moreover, a skilled person would understand how to create shuffles that internally interconnect differing numbers of nodes or clients as desired for a particular implementation, e.g. shuffles that can interconnect 8, 16, 24, 48, 96, etc. nodes or clients, in any number of different dimensions etc. as desired. In addition, a skilled person would understand how to elegantly implement any number of different embodiments or configurations of shuffles that are capable of connecting any number of nodes or clients to any number of devices or peripheral components as desired. Accordingly, those skilled in the art would recognize that certain modifications, permutations, additions, and sub-combinations of various aspects of shuffles and their components may be made. For example (without limitation):
In other embodiments, the shuffle (lower level shuffle) may comprise only node ports and not have any trunk ports to allow for expansion of the network, including in additional dimensions, beyond the network topology as internally wired within the shuffle;
In other embodiments, the optical connectors may be of a different type or may comprise a lower or higher number of fibers to meet the needs of the desired network topology;
In other embodiments, the R-keys may similarly be of a different type or comprise a lower or higher number of fibers to meet the needs of the desired network topology;
In other embodiments, the bulkhead adapters may be modified to hold the desired connectors in place, or may be replaced by a mechanism or component that serves a similar purpose;
In other embodiments, the shuffle cables and their fibers may be of a different type, mode, etc., or comprise a lower or higher number of fibers to meet the needs of the desired network topology;
In other embodiments, the internal fiber shuffle sub-assembly may employ a different fiber management solution or may be replaced by a mechanism or component that serves a similar purpose;
In other embodiments, other related means of achieving “enhanced connectivity” may be provided;
In other embodiments, the shuffle may be embodied in a different form factor or housing, e.g. one that does not necessarily require a chassis, etc.

It will thus be apparent to one skilled in the art that variations and modifications to the embodiments may be made within the scope of the following claims.

1. A passive optical device for implementing a direct interconnect network of nodes or clients in a network topology, said device comprising:
a housing comprising a plurality of node port connectors and an internal fiber shuffle mechanism,
wherein each of said plurality of node port connectors is connected to a node port shuffle cable that extends within the housing to the internal fiber shuffle mechanism, and wherein each of said plurality of node port shuffle cables comprises transmit and receive optical fibers that are cross connected within the internal fiber shuffle mechanism to transmit and receive optical fibers of other of the node port shuffle cables from the plurality of node port connectors to form optical paths between said node port connectors to implement the network topology,
and wherein each of said node port connectors is also initially connected to a first-type R-key to maintain in-line connections within the network topology, and wherein said first-type R-keys are replaceable in a pre-determined order by a connection to a node or client to add said node or client at an optimal location within the network topology during build out of the direct interconnect network.

2. The passive optical device of claim 1, wherein the housing further includes:
a plurality of trunk port connectors, wherein each of said plurality of trunk port connectors is connected to a trunk port shuffle cable that extends within the housing to the internal fiber shuffle mechanism, and wherein each of said plurality of trunk port shuffle cables comprises transmit and receive optical fibers that are cross connected within the internal fiber shuffle mechanism to transmit and receive optical fibers of node port shuffle cables from the plurality of node port connectors within the network topology,
and wherein each of said trunk port connectors is also initially connected to a second-type R-key to provide enhanced connectivity within the network topology, and wherein said second-type R-keys are replaceable by a connection to another passive optical device to expand the direct interconnect network.

3. The passive optical device of claim 2, wherein the network topology is any one of a torus, dragon fly, slim fly, or other higher radix direct interconnect network topology.

4. An optical lower level shuffle for implementing a direct interconnect network of nodes or clients in a network topology, said shuffle comprising:
a plurality of node port connectors, each such connector connected to fiber optic fibers that are cross connected in the shuffle with fiber optic fibers of other of the plurality of node port connectors to implement the network topology in one or more dimensions, and
a plurality of trunk port connectors, each such connector connected to fiber optic fibers that are cross connected in the shuffle with fiber optic fibers of the plurality of node port connectors to allow for expansion of the network topology in one or more additional dimensions through connection to at least one upper level shuffle,
wherein each node port connector is initially populated by a first-type R-key to initially close one or more connections of the direct interconnect network, and wherein each of said first-type R-key is replaceable in a pre-determined order by a connection to a node or client to add said node or client at an optimal location in the network topology during build out of the direct interconnect network,
and wherein each trunk port connector is initially populated by a second-type R-key to provide enhanced connectivity between nodes or clients in the direct interconnect network, and wherein each of said second-type R-key is replaceable by a connection to an upper level shuffle to expand the network topology in one or more additional dimensions.

5. The optical lower level shuffle of claim 4, wherein the network topology is any one of a torus, dragon fly, slim fly, or other higher radix direct interconnect network topology.

6. An optical lower level shuffle for implementing a direct interconnect network of nodes or clients in a network topology, said shuffle comprising:
a chassis comprising a faceplate and housing an internal fiber shuffle sub-assembly, wherein said faceplate includes node ports comprising node port connectors,
wherein each of said node port connectors is connected on an internal face of the faceplate to a node port shuffle cable having a plurality of transmit and receive fibers extending into the internal fiber shuffle sub-assembly and cross connected therein with transmit and receive fibers of other of the node port shuffle cables in a pre-determined manner to form optical paths between said node port connectors to implement the network topology,
and wherein each of said node port connectors is initially connected on an external face of the faceplate to a primary fiber R-key for maintaining in-line connections in the direct interconnect network, said primary fiber R-keys replaceable in a pre-determined order with a connection to a node or client to add said node or client at an optimal location within the network topology during build out of the direct interconnect network.

7. The optical lower level shuffle of claim 6, where the faceplate further includes trunk ports comprising trunk port connectors,
wherein each of said trunk port connectors is connected on an internal face of the faceplate to a trunk port shuffle cable having a plurality of transmit and receive fibers extending into the internal fiber shuffle sub-assembly and cross connected therein with transmit and receive fibers of the node port shuffle cables to allow for network expansion,
and wherein each of said trunk port connectors is initially connected on an external face of the faceplate to a secondary fiber R-key for providing enhanced connectivity between nodes or clients in the direct interconnect network, said secondary fiber R-keys replaceable with a connection to an optical upper level shuffle for network or dimension expansion.

8. The optical lower level shuffle of claim 7, wherein the network topology is any one of a torus, dragon fly, slim fly, or other higher radix direct interconnect network topology.

9. An optical upper level shuffle for increasing network or dimension expansion of a direct interconnect network of nodes or clients interconnected in a lower level shuffle, said optical upper level shuffle comprising:
a housing comprising a plurality of connectors and an internal fiber shuffle mechanism,
wherein said plurality of connectors are organized into groups of connectors, wherein each connector within each group of connectors is connected to fiber optic fibers that are cross connected in the internal fiber shuffle mechanism with fiber optic fibers of at least one other connector in the same group of connectors to implement dimension loops,
and wherein each connector in the plurality of connectors is connectable to a trunk port connector in the lower level shuffle to increase network or dimension expansion of the direct interconnect network.

10. An optical upper level shuffle for increasing network or dimension expansion of a direct interconnect network of nodes or clients interconnected in a lower level shuffle, said optical upper level shuffle comprising:
a chassis comprising a faceplate and housing an internal fiber shuffle sub-assembly, wherein said faceplate includes a plurality of connectors organized into groups of connectors,
wherein each connector within each group of connectors is connected on an internal face of the faceplate to a shuffle cable having a plurality of transmit and receive fibers extending into the internal fiber shuffle sub-assembly and cross connected therein with transmit and receive fibers of at least one other of the shuffle cables in the same group of connectors to form optical paths between said connectors to implement dimension loops,
and wherein each connector in the plurality of connectors is connectable to a trunk port connector in the lower level shuffle to increase network or dimension expansion of the direct interconnect network.

11. The optical upper level shuffle of claim 10, wherein the lower level shuffle interconnects nodes or clients in a torus, dragon fly, slim fly, or other higher radix direct interconnect network topology.

12. A passive optical device for directly connecting nodes or clients to devices or peripheral components, said device comprising:
a housing comprising a plurality of connectors organized into at least two groups of connectors, namely
at least one first group of node connectors, and
at least one second group of device connectors,
wherein each node connector in the at least one first group of node connectors is connected within the housing to a shuffle cable comprising transmit and receive optical fibers that is connected to at least one device connector within the at least one second group of device connectors to provide two-way node or client to device or peripheral component connectivity,
and wherein each node connector in the at least one first group of node connectors is connectable to an external node or client,
and wherein each device connector in the at least one second group of device connectors is connectable to an external device or peripheral component.

13. A method of implementing a direct interconnect network of nodes or clients in a network topology comprising the following steps:
providing a passive optical device that internally implements the wiring for the direct interconnect network in the network topology, said device comprising a faceplate having a plurality of node ports comprising node port connectors connectable to nodes or clients in one or more dimensions;
initially populating each of said node port connectors with a first-type R-key to close connections to maintain continuity of the network topology; and
removing in a pre-determined order a first-type R-key from a node port connector and replacing said first-type R-key with a connection to a node or client to add said node or client to the direct interconnect network at a specific location within the network topology during build out of the direct interconnect network.

14. The method of claim 13, wherein the faceplate further has a plurality of trunk ports comprising trunk port connectors connectable to at least one other passive optical device for expansion of the direct interconnect network in one or more additional dimensions;
initially populating each of said trunk port connectors with a second-type R-key to provide enhanced connectivity between nodes or clients in the network topology; and
removing a second-type R-key from a trunk port connector and replacing said second-type R-key with a connection to the at least one other passive optical device to expand the direct interconnect network in one or more additional dimensions.

15. The method of claim 14, wherein the network topology is any one of a torus, dragon fly, slim fly, or other higher radix direct interconnect network topology.

16. A method of implementing a direct interconnect network of nodes or clients in a network topology comprising the following steps:
providing an optical lower level shuffle comprising a chassis having a faceplate and housing an internal fiber shuffle sub-assembly,
wherein said faceplate includes node ports comprising node port connectors, and wherein each of said node port connectors is connected on an internal face of the faceplate to a node port shuffle cable having a plurality of transmit and receive fibers extending into the internal fiber shuffle sub-assembly and cross connected therein in a pre-determined manner with transmit and receive fibers of other of the node port shuffle cables to form optical paths between said node port connectors to implement the network topology,
initially connecting each of the node port connectors on an external face of the faceplate with a primary fiber R-key to maintain in-line connections in the direct interconnect network, and
replacing primary fiber R-keys in a pre-determined order with a connection to a node or client to add said node or client to the direct interconnect network at an optimal location within the network topology during build out of the direct interconnect network.

17. The method of claim 16, wherein the faceplate further includes trunk ports comprising trunk port connectors, and wherein each of said trunk port connectors is connected on an internal face of the faceplate to a trunk port shuffle cable having a plurality of transmit and receive fibers extending into the internal fiber shuffle sub-assembly and cross connected therein in a pre-determined manner with transmit and receive fibers of the node port shuffle cables to form optical paths between said node port and trunk port connectors to allow for network expansion,
initially connecting each of the trunk port connectors on an external face of the faceplate with a secondary fiber R-key to provide enhanced connectivity between nodes or clients in the direct interconnect network,
providing an optical upper level shuffle for increasing network or dimension expansion of the direct interconnect network of nodes or clients interconnected in the lower level shuffle, said optical upper level shuffle comprising:
a chassis comprising a faceplate and housing an internal fiber shuffle sub-assembly, wherein said faceplate includes a plurality of connectors organized into groups of connectors,
wherein each connector within each group of connectors is connected on an internal face of the faceplate to a shuffle cable having a plurality of transmit and receive fibers extending into the internal fiber shuffle sub-assembly and cross connected therein with transmit and receive fibers of at least one other of the shuffle cables in the same group of connectors to form optical paths between said connectors to implement dimension loops, and
replacing secondary fiber R-keys in the lower level shuffle with a connection to a connector in the upper level shuffle to expand the direct interconnect network.

18. The method of claim 17, wherein the network topology is any one of a torus, dragon fly, slim fly, or other higher radix direct interconnect network topology.

19. A passive optical device for implementing a direct interconnect network of nodes or clients in a network topology, said device comprising:
(a) a plurality of node port connectors;
(b) a plurality of node port shuffle cables;
(c) at least one first-type R-key; and
(d) a fiber shuffle mechanism,
wherein each of said plurality of node port connectors is connected to the fiber shuffle mechanism via a corresponding one of the plurality of node port shuffle cables,
wherein each of said plurality of node port shuffle cables comprises transmit and receive optical fibers that are connected within the fiber shuffle mechanism to transmit and receive optical fibers of other of the node port shuffle cables from the plurality of node port connectors to form optical paths between said node port connectors to implement a network topology,
wherein at least one of said node port connectors is initially connected to one of the at least one first-type R-key to maintain in-line connections within the network topology, and
wherein said at least one first-type R-key are replaceable in a pre-determined order by a connection to a node or a client to add said node or said client at an optimal location within the network topology during build out of a direct interconnect network.

20. The passive optical device of claim 19, further comprising:
(a) a plurality of trunk port connectors;
(b) a plurality of trunk port shuffle cables; and
(c) at least one second-type R-key,
wherein each of said plurality of trunk port connectors is connected to the fiber shuffle mechanism via a corresponding one of the plurality of trunk port shuffle cables, wherein each of said plurality of trunk port shuffle cables comprises transmit and receive optical fibers that are connected within the fiber shuffle mechanism to transmit and receive optical fibers of node port shuffle cables from the plurality of node port connectors within the network topology,
wherein at least one of said trunk port connectors is initially connected to one of the at least one second-type R-key to provide enhanced connectivity within the network topology, and
wherein said second-type R-keys are replaceable by a connection to another passive optical device to expand the direct interconnect network.
